(19) United States
(12) Patent Application Publication
(10) Pub. No.: US 2016/0202409 A1
(43) Pub. Date: Jul. 14, 2016

(54) DOUBLE-SIDED OPTICAL FILM WITH LENSLETS AND CLUSTERS OF PRISMS

(71) Applicant: 3M INNOVATIVE PROPERTIES COMPANY, Saint Paul, MN (US)

(72) Inventor: Michael J. Sykora, New Richmond, WI (US)

(21) Appl. No.: 14/913,120

(22) PCT Filed: Sep. 3, 2014
(86) PCT No.: PCT/US2014/053859

§ 371 Date: Feb. 19, 2016

Related U.S. Application Data
(60) Provisional application No. 61/874,183, filed on Sep. 5, 2013.

(51) Int. Cl. F21V 8/00; G02B 5/04; G02B 3/00

(52) U.S. Cl. CPC G02B 6/0053; G02B 3/0068; G02B 5/045; G02B 6/0068

(57) ABSTRACT

An optical film has a structured surface with elongated lenslets formed therein and an opposed structured surface with elongated prisms formed therein. The lenslets extend parallel to each other and to an elongation axis which is generally parallel to the film plane, and the prisms also extend parallel to each other and to the elongation axis. The prisms are grouped into separated clusters of adjacent prisms. Each prism cluster is associated with a corresponding one of the lenslets, and has at least 3 prisms. Each lenslet defines a focal point and a focal surface. Vertices of the prisms in a prism cluster are disposed at or near the focal surface of the associated lenslet. When illuminated with oblique light, each lenslet/prism cluster pair, and optionally the optical film as a whole, may produce N angularly separated light beams, N being the number of prisms in each prism cluster.

### FIELD

This invention relates generally to microstructured optical films, particularly to such films in which the opposed major surfaces are both structured, as well as articles and systems that incorporate such films, and methods pertaining to such films.

### BACKGROUND

Optical films that have structured surfaces on opposed major surfaces thereof, referred to herein as dual-sided optical films, are known. In some such films, one structured surface has lenticular features formed therein and the other structured surface has prismatic features formed therein. There is a one-to-one correspondence of prismatic features to lenticular features, and individual prismatic features are elongated and extend parallel to each other and to individual lenticular features, which are also elongated. Such films have been disclosed for use as optical light redirecting films in autostereoscopic 3D display systems. See for example U.S. Pat. No. 8,035,771 (Brott et al.) and U.S. Pat. No. 8,068,187 (Huizinga et al.), and patent application publications US 2005/0052750 (King et al.), US 2011/0149391 (Brott et al.), and US 2012/0236403 (Sykora et al.).

### BRIEF SUMMARY

We have developed a new family of dual-sided optical films in which a first structured surface has elongated lenslets formed therein, and a second structured surface, opposed to the first structured surface, has elongated prisms formed therein. The lenslets extend parallel to each other and to an elongation axis which is generally parallel to the film plane, and the prisms also extend parallel to each other and to the elongation axis. The prisms are grouped into separated clusters of adjacent prisms. Each prism cluster is associated with a corresponding one of the lenslets, and has at least 3 prisms. Each lenslet defines a focal point and a focal surface. Vertices of the prisms in a prism cluster are disposed at or near the focal surface of the associated lenslet. For example, a focal space may be defined as a space that encompasses the focal surface and has boundaries that are separated from the focal surface by a differential distance DD equal to 20% of the axial focal length of the lenslet, and the prism vertices of the prisms in the prism cluster associated with the lenslet are disposed in the focal space of the lenslet. When illuminated with oblique light, each lenslet/prism cluster pair, and optionally the optical film as a whole, may produce N angularly separated light beams, N being the number of prisms in each prism cluster.

The present application thus discloses, among other things, optical film that have opposed first and second structured surfaces, the first structured surface having a plurality of elongated lenslets formed thereon, and the second structured surface having a plurality of elongated prisms formed thereon. The plurality of lenslets are elongated along respective lenslet axes which are parallel to an elongation axis, and the elongated prisms have respective elongated prism vertices which are also parallel to the elongation axis. The prisms are grouped into prism clusters that are separated from each other, each prism cluster having at least three of the prisms, and each prism cluster being associated with a corresponding one of the lenslets. Each lenslet defines a focal surface, and for each lenslet, the prism vertices of the prisms in the prism cluster associated with the lenslet are disposed at or near the focal surface. For example, for each lenslet, the lenslet may have an axial focal length, and a focal space encompasses the focal surface and has boundaries that are separated from the focal surface by a differential distance DD equal to 20% of the axial focal length, and the prism vertices of the prisms in the prism cluster associated with the lenslet may be disposed in the focal space of the lenslet. In some cases, for each lenslet, the prism vertices of the prisms in the prism cluster associated with the lenslet may be disposed in a portion of the focal space between the focal surface and the lenslet.

For each lenslet, the prism vertices of the prisms in the prism cluster associated with the lenslet may lie in a plane. For each lenslet, the focal surface may have a first curved shape in a cross-sectional plane perpendicular to the elongation axis. The prism vertices of the prisms in the prism cluster associated with each lenslet may be arranged along a second curved shape in the cross-sectional plane, and the first and second curved shapes may have the same polarity, e.g., both may be concave or both may be convex. Each prism cluster may include 5 of the prisms, or 10 of the prisms. The prism clusters may each contain a same number N of the prisms, where N is at least 3, or at least 5, or at least 10.

For each lenslet, the associated prism cluster may have N of the prisms, and the lenslet may cooperate with its associated prism cluster to provide, when the second structured surface is illuminated with oblique light from a first light source, a first lenslet light output defining N angularly separated light beams, and N may be at least 3. The film may be combined with a diffuser film disposed to receive the first lenslet light output to convert the N angularly separated light beams to one light beam.

The optical film may define a film plane and a thickness axis perpendicular to the film plane, and at least some of the lenslets may have a compound curvature in a cross-sectional plane perpendicular to the elongation axis. Such lenslets may also have respective lenslet axes of symmetry in the cross-sectional plane, and at least some of the lenslet axes of symmetry may be tilted relative to the thickness axis. Similarly, the prisms may have respective prism axes of symmetry in the cross-sectional plane, and at least some of the prism axes of symmetry may be tilted relative to the thickness axis.

The lenslets may be spaced according to a lenslet pitch and the prism clusters may be spaced according to a cluster pitch, and the lenslet pitch may equal the cluster pitch. Alternatively, the lenslet pitch may not equal the cluster pitch. The optical film may be combined with a diffuser film disposed proximate the first structured surface.

We also disclose optical systems in which the dual-sided optical film is combined with a light guide having a major surface adapted to emit light preferentially at oblique angles, and the optical film may be disposed proximate the light guide and oriented so that light emitted from the major surface of the light guide enters the optical film through the second structured surface of the optical film. The system may also include a first and second light source disposed proximate respective first and second opposed ends of the light guide, the first and second light sources providing different respective first and second oblique light beams emitted from the major surface of the light guide. The optical film and the light guide may be non-planar. The optical film and the light guide may be flexible. The optical film may be attached to the light guide.

Related methods, systems, and articles are also discussed.

These and other aspects of the present application will be apparent from the detailed description below. In no event, however, should the above summaries be construed as limitations on the claimed subject matter, which subject matter is defined solely by the attached claims, as may be amended during prosecution.

### BRIEF DESCRIPTION OF THE DRAWINGS

Inventive aspects of the disclosure may be more completely understood in connection with the accompanying drawings, in which:

FIG. 1A is a schematic side view of an illustrative lighting system that includes a dual-sided optical film;

FIG. 1B is a schematic perspective view of some components of the lighting system of FIG. 1A;

FIG. 2 is a schematic perspective view of a light guide, which shows in exaggerated fashion exemplary surface structure on the two major surfaces of the light guide;

FIG. 2A is a view of the light guide of FIG. 2 in combination with collimated light sources, illustrating how a light guide can be effectively subdivided or partitioned as a function of which light sources on a given side of the light guide are turned ON;

FIG. 3 is a schematic side view of the lighting system of FIG. 1A, with one light source energized, this light source producing a first set of output beams emerging from the dual-sided optical film;

FIG. 4 is a schematic side view similar to FIG. 3, but with the opposite light source energized, this light source producing a second set of output beams emerging from the dual-sided optical film;

FIG. 5 is a schematic side or sectional view of a portion of a dual-sided optical film;

FIG. 5A is a schematic side or sectional view of one of the lenslets from FIG. 5, and FIG. 5B is a schematic side or sectional view of one of the prism clusters from FIG. 5, and FIG. 5C is an idealized graph of a hypothetical lenslet light output defining N angularly separated light beams that may be produced when oblique light illuminates the second structured surface of the film of FIG. 5;

FIG. 6 is a schematic side or sectional view of a portion of a dual-sided optical film similar to that of FIG. 5, but where the prism vertices in each cluster of prisms are non-coplanar, and FIG. 6A is a schematic side or sectional view of one of the prism clusters from FIG. 6;

FIG. 7 is a schematic side or sectional view of a portion of a dual-sided optical film similar to that of FIG. 5, but where adjacent prism clusters are separated by a flat surface rather than a deep V-groove;

FIG. 8 is a schematic side or sectional view of a portion of a dual-sided optical film similar to that of FIG. 6, but where adjacent prism clusters are separated by a flat surface rather than a deep V-groove;

FIG. 9 is a schematic side or sectional view of an exemplary dual-sided optical film in which the lenslets are aligned with their respective prism clusters, and a pitch of the lenslets is the same as the pitch of the prism clusters;

FIG. 10 is a schematic side or sectional view of an exemplary dual-sided optical film in which the pitch of the lenslets is different from the pitch of the prism clusters;

FIG. 10A is another schematic side or sectional view of the film of FIG. 10, which shows how the optical axes of the lenslet/prism cluster pairs are not parallel to each other, and their relationship to the optical axis of the film;

FIG. 11 is a schematic side or sectional view of a lenslet of an exemplary film, the lenslet having compound curvature and a symmetry axis or optical axis;

FIG. 12 is a schematic side or sectional view of a lenslet/prism cluster pair whose optical axis is tilted relative to a thickness axis of the film, with the lenslet having a lenslet axis of symmetry that is tilted relative to the thickness axis and with individual prisms whose prism axes of symmetry are also tilted relative to the thickness axis;

FIG. 13 is a schematic perspective view of a dual-sided optical film;

FIG. 13A is a graph of the modeled brightness of a lenslet light output for the film of FIG. 13 when the second structured surface is illuminated with obliquely incident light from a first light source, and

FIG. 13B is a similar graph but when the second structured surface is illuminated with obliquely incident light from a second light source opposite the first light source;

FIG. 13C is a graph that superimposes the traces from FIGS. 13A and 13B on top of each other, and FIG. 13D is a graph that shows the combination of those traces;

FIG. 14 is a schematic side or sectional view of a dual-sided optical film, and FIG. 14A is a graph of the modeled film light output for this film when the second structured surface is illuminated with obliquely incident light;

FIG. 15 is a schematic side or sectional view of another dual-sided optical film, and FIG. 15A is a graph of the modeled film light output for this film when the second structured surface is illuminated with obliquely incident light;

FIG. 16 is a schematic side or sectional view of another dual-sided optical film, and FIG. 16A is a graph of the modeled film light output for this film when the second structured surface is illuminated with obliquely incident light;

FIG. 17 is a schematic side or sectional view of another dual-sided optical film, and FIG. 17A is a graph of the modeled film light output for this film when the second structured surface is illuminated with obliquely incident light;

FIG. 18 is a schematic side or sectional view of the film of FIG. 17 in combination with a diffuser film, and FIG. 18A is a graph showing how the diffuser can modify or smooth the film light output from FIG. 17A; and

FIGS. 19A through 19E are schematic perspective views of optical systems which demonstrate some planar and non-planar shapes that the dual-sided optical film and/or its associated light guide may have.

The schematic drawings presented herein are not necessarily to scale; however, graphs are assumed to have accurate scales unless otherwise indicated. Like reference numerals used in the figures refer to like elements.

### DETAILED DESCRIPTION

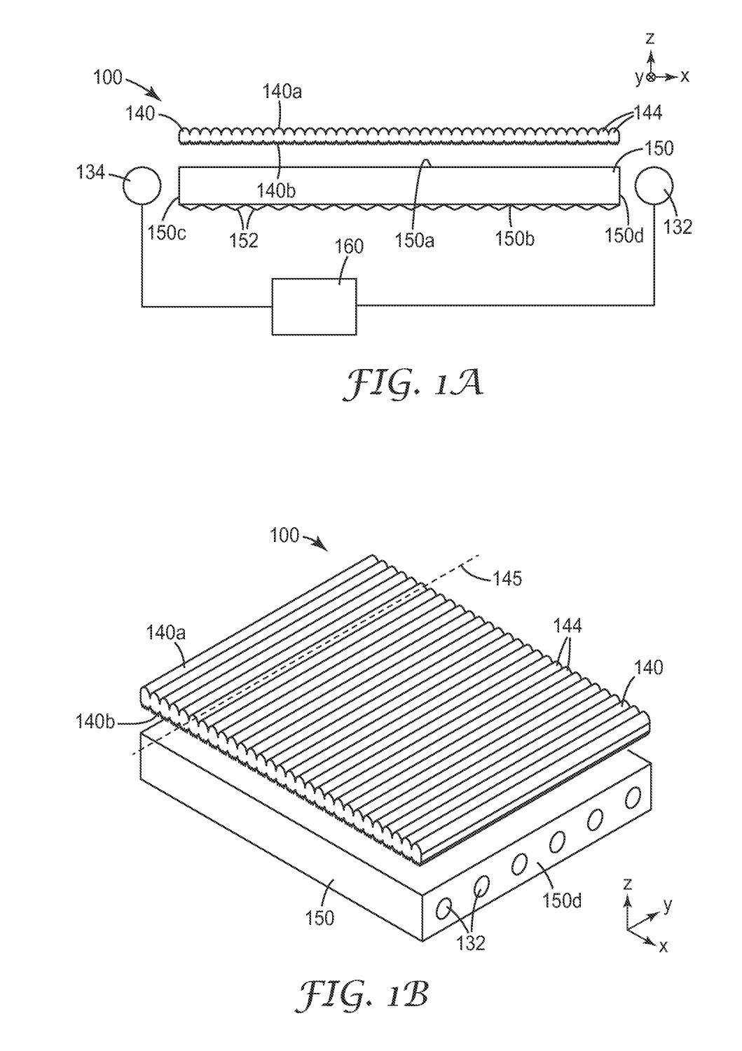

An optical system 100 capable of utilizing the unique properties of the disclosed dual-sided optical films is shown in FIG. 1A. The optical system 100 may be part of a display system, but other devices and applications, including ambient lighting devices such as luminaires, task lights, and static backlit signs, are also contemplated. The system 100 is shown in relation to a Cartesian x-y-z coordinate system so that directions and orientations of selected features can be more easily discussed. The system 100 includes one or more light guides 150, one or more first light sources 134, and one or more second light sources 132. The system 100 also includes a dual-sided optical film 140, further details of which are discussed below. The x-y plane of the coordinate system is assumed to lie parallel to the plane of the film 140, which is also typically parallel to the plane of the light guide 150.

The light sources 132, 134 are disposed on opposite ends of the light guide, and inject light into the light guide from opposite directions. Each of the light sources may emit light that is nominally white and of a desired hue or color temperature. Alternatively, each light source may emit colored light, e.g., light perceived to be red, green, blue, or another known non-white color, and/or may emit ultraviolet and/or infrared (including near infrared) light. The light sources may also be or comprise clusters of individual light emitting devices, some or all of which may emit non-white colored light, but the combination of light from the individual devices may produce nominally white light, e.g. from the summation of red, green, and blue light. Light sources on opposite ends of the light guide may emit light of different white or non-white colors, or they may emit light of the same colors. The light sources 132, 134 can be of any known design or type, e.g., one or both may be or comprise cold cathode fluorescent lamps (CCFLs), and one or both may be or comprise one or more inorganic solid state light sources such as light emitting diodes (LEDs) or laser diodes, and one or both may be or comprise one or more organic solid state light sources such as organic light emitting diodes (OLEDs). The round shapes used to represent the light sources in the drawings are merely schematic, and should not be construed to exclude LED(s), or any other suitable type of light source. The light sources 132, 134 are preferably electronically controllable such that either one can be energized to an ON state (producing maximum or otherwise significant light output) while keeping the other one in an OFF state (producing little or no light output), or both can be in the ON state at the same time if desired, and both may be turned OFF during non-use. In many cases, the light sources 132, 134 do not need to satisfy any particular requirement with regard to switching speed. For example, although either or both light sources 132, 134 may be capable of repetitively transitioning between the OFF state and the ON state at a rate that is imperceptible to the human eye (e.g., at least 30 or 60 Hz), such a capability is not necessary in many embodiments. (For flicker-free operation, transition rates may be in a range from 50 to 70 Hz, or more; for two-sided operation, transition rates may be in a range from 100 to 140 Hz (or more) for the display panel (if any) and the light sources.) Thus, light sources that have much slower characteristic transition times between the ON and OFF states can also be used.

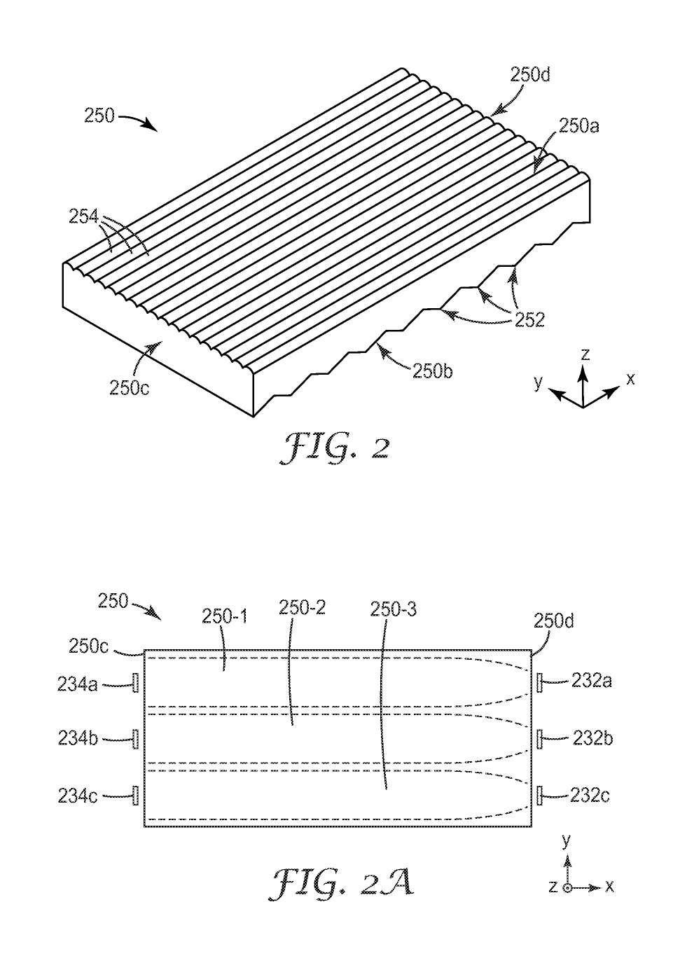

The light guide 150 includes a first light input side 150c adjacent to the first light source 134 and an opposing second light input side 150d adjacent to the second light source 132. A first light guide major surface 150b extends between the first side 150c and second side 150d. A second light guide major surface 150a, opposite the first major surface 150b, also extends between the first side 150c and the second side 150d. The major surfaces 150b, 150a of the light guide 150 may be substantially parallel to each other, or they may be non-parallel such that the light guide 150 is wedge-shaped. Light may be reflected or emitted from either surface 150b, 150a of the light guide 150, but in general light is emitted from surface 150a and is reflected from surface 150b. In some cases, a highly reflective surface may be provided on or adjacent to the first surface 150b to assist in re-directing light out through the second surface 150a. Light extraction features such as shallow prism structures 152, or other light extraction features such as lenticular features, white dots, haze coatings, and/or other features, may be disposed on one or both major surfaces 150b, 150a of the light guide 150. Exemplary light extraction features for the light guide are discussed below in connection with FIG. 2. The light extraction features are typically selected so that light emitted from the major surface 150a propagates preferentially at highly oblique angles in air as measured in the x-z plane, rather than propagating at normal or near-normal propagation directions that are parallel to, or deviate only slightly from, the z-axis (again as measured in the x-z plane). For example, the light emitted from the surface 150a into air may have a peak intensity direction that makes an angle relative to the surface normal (z-axis) of 60 degrees or more, or 70 degrees or more, or 80 degrees or more, where the peak intensity direction refers to the direction along which the intensity distribution of the output beam in the x-z plane is a maximum.

The light guide 150 may have a solid form, i.e., it may have an entirely solid interior between the first and second major surfaces 150a, 150b. The solid material may be or comprise any suitable light-transmissive material, such as glass, acrylic, polyester, or other suitable polymer or non-polymer materials. Alternatively, the light guide 150 may be hollow, i.e., its interior may be air or another gas, or vacuum. If hollow, the light guide 150 is provided with optical films or similar components on opposite sides thereof to provide the first and second major surfaces 150a, 150b. Hollow light guides may also be partitioned or subdivided into multiple light guides. Whether solid or hollow, the light guide 150 may be substantially planar, or it may be non-planar, e.g., undulating or curved, and the curvature may be slight (close to planar) or great, including cases where the light guide curves in on itself to form a complete or partial tube. Such tubes may have any desired cross-sectional shape, including curved shapes such as a circle or ellipse, or polygonal shapes such as a square, rectangle, or triangle, or combinations of any such shapes, A hollow tubular light guide may in this regard be made from a single piece of optical film or similar component(s) that turns in on itself to form a hollow tube, in which case the first and second major surfaces of the light guide may both be construed to be provided by such optical film or component(s). The curvature may be only in the x-z plane, or only in the y-z plane, or in both planes. Although the light guide and dual-sided film may be non-planar, for simplicity they are shown in the figures as being planar; in the former case one may interpret the figures as showing a small enough portion of the light guide and/or optical film such that it appears to be planar. Whether solid or hollow, depending on the material(s) of construction and their respective thicknesses, the light guide may be physically rigid, or it may be flexible. A flexible light guide or optical film may be flexed or otherwise manipulated to change its shape from planar to curved or vice versa, or from curved in one plane to curved in an orthogonal plane.

The dual-sided optical film 140, which is assumed to lie in or define a film plane generally parallel to the x-y plane, is disposed to receive obliquely-emitted light from the light guide 150. The film 140 has a first structured surface 140a, and a second structured surface 140b opposite the first structured surface. Elongated lenslets 144 are formed in the structured surface 140a, which is oriented generally away from the light guide 150.

Elongated prisms (shown better in figures that follow) are formed in the second structured surface 140b, which is oriented generally towards the light guide 150. In this orientation, light emitted from the major surface 150a of the light guide 150 is incident on the prisms, which help to deviate the incident light. The incident light is deviated by and passes through the film 140 to provide a film light output that emerges from the film 140. As described further below, the properties of the film light output can be influenced by which of the light sources 132, 134 is in an ON state, as well as by the spatial relationships between the lenslets and the prisms. When one light source is ON, a first film light output may comprise a first group of N angularly separated light beams. When the opposite light source is ON, a second film light output may comprise a second group of N angularly separated light beams, which beams may be substantially aligned with, or not aligned with, the first group of light beams. As shown better in other figures below, the prisms are grouped into clusters of adjacent prisms, the clusters being separated from each other, and each prism cluster being associated with a corresponding one of the lenslets. These prisms have sharp apexes so as to provide beam edges, measured e.g. from a plot of intensity versus angle, that are sharp.

Both the prisms and the lenslets 144 are typically linear, or, in cases where one or both are not precisely linear (e.g. not straight), they are otherwise extended or elongated along a particular in-plane axis. Thus, the lenslets 144 may extend along lenslet axes that are parallel to each other. One such axis is shown in FIG. 1B as axis 145, which is assumed to be parallel to the y-axis. The prisms may extend along respective prism axes that are parallel to each other. The lenslet axes of elongation are typically parallel to the prism axes of elongation. Perfect parallelism is not required, and axes that deviate slightly from perfect parallelism may also be considered to be parallel; however, misalignment results in different amounts of registration between a given lenslet/prism cluster pair at different places along their length on the working surface of the dual-sided film—and such differences in the degree of registration (regardless of whether the degree of registration is tailored to have precise alignment, or intentional misalignment, of the relevant vertices or other reference points, as discussed below) are desirably about 1 micron or less. In some cases, extraction features such as prism structures 152 on the major surface 150b of the light guide may be linear or elongated along axes that are parallel to the elongation axes of the lenslets and prisms of the film 140; alternatively, such extraction features of the light guide 150 may be oriented at other angles.

In the film 140 or pertinent portion thereof, there is a one-to-one correspondence of lenslets 144 to prism clusters. Thus, for each prism cluster there is a unique lenslet 144 with which the given prism cluster primarily interacts, and vice versa. One, some, or all of the lenslets 144 may be in substantial registration with their respective prism clusters. Alternatively, the film 140 may be designed to incorporate a deliberate misalignment or mis-registration of some or all of the lenslets relative to their respective prism clusters. Related to alignment or misalignment of the lenslets and prism clusters is the center-to-center spacings or pitches of these elements. In the case of a display system, the pitch of the lenslets 144 and the pitch of the prism clusters (as well as the pitch of the individual prisms in the prism clusters) may be selected to reduce or eliminate Moire patterns with respect to periodic features in the display panel. These various pitch dimensions can also be determined or selected based upon manufacturability. Useful pitch ranges for the lenslets 144 and the prism clusters on the respective structured surfaces of the optical film 140 is about 10 microns to about 140 microns, for example, but this should not be interpreted in an unduly limiting way.

The system 100 can have any useful shape or configuration. In many embodiments, the light guide 150, and/or the dual-sided optical film 140 can have a square or rectangular shape. In some embodiments, however, any or all of these elements may have more than four sides and/or a curved shape.

A switchable driving element 160 is electrically connected to the first and second light sources 132, 134. This element may contain a suitable electrical power supply, e.g. one or more voltage sources and/or current sources, capable of energizing one or both of the light sources 132, 134. The power supply may be a single power supply module or element, or a group or network of power supply elements, e.g., one power supply element for each light source. The driving element 160 may also contain a switch that is coupled to the power supply and to the electrical supply lines that connect to the light sources. The switch may be a single transistor or other switching element, or a group or network of switching modules or elements. The switch and power supply within the driving element 160 may be configured to have several operational modes. These modes may include two, three, or all of: a mode in which only the first light source 134 is ON; a mode in which only the second light source 132 is ON; a mode in which both the first and second light sources are ON; and a mode in which neither of the first and second light sources are ON (i.e., both are OFF).

We describe in more detail below how the dual-sided optical film 140, when provided with separated clusters of adjacent prisms, can provide the optical system with the capability to produce a light output characterized by a group of light beams that are closely spaced but separated from each other in output angle. The group of beams has sharp edges at two opposite boundaries of the beams, and the individual beams may also have sharp edges. The characteristics and features of the light output are controlled by design details of the lenslets and prism clusters, as explained further below.

FIG. 1B is a schematic perspective view of the optical system 100 showing the light guide 150, the optical film 140, and the second light sources 132. Like elements between FIGS. 1A and 1B have like reference numerals, and need not be further discussed. The optical film 140 includes lenslets 144 oriented away from the light guide 150 and prisms with prism peaks oriented toward the light guide 150. The axis of elongation 145 of the lenslets, which may also correspond to the axis of elongation of the prisms, is shown to be parallel to the y-axis. In the case of the prisms of the structured surface 140b, the elongation axis runs parallel to the vertex of the prism. The film 140 is shown to be adjacent the light guide 150 but spaced slightly apart. The film 140 may also be mounted or held so that it is in contact with the light guide 150, e.g. the film 140 may rest upon the light guide 150, while still substantially maintaining an air/polymer interface at the facets or inclined side surfaces of the prisms (with a physically thin but optically thick layer of air) so that their refractive characteristics can be preserved. Alternatively, a low refractive index bonding material may be used between the prisms and the light guide 150 to bond the film 140 to the light guide. In this regard, nanovoided materials having an ultra low index (ULI) of refraction are known that can come somewhat close in refractive index to air, and that can be used for this purpose. See e.g. patent application publications WO 2010/120864 (Hao et al.) and WO 2011/088161 (Wolk et al.), which discuss ULI materials whose refractive index (n) is in a range from about n≈1.15 to n≈1.35. See also patent application publications WO 2010/120422 (Kolb et al.), WO 2010/120468 (Kolb et al.), WO 2012/054320 (Coggio et al.), and US 2010/0208349 (Beer et al.). Air gap spacing techniques, e.g. wherein an array of microreplicated posts is used to bond the two components together while substantially maintaining an air gap between them, may also be used. See e.g. patent application publication US 2013/0039077 (Edmonds et al.).

The disclosed dual-sided optical films and associated components may be provided in a variety of forms and configurations. In some cases, the dual-sided optical film may be packaged, sold, or used by itself, e.g. in piece, sheet, or roll form. In other cases, the dual-sided optical film may be packaged, sold, or used with a light guide whose output beam characteristics are tailored for use with the dual-sided film. In such cases, the dual-sided film may be bonded to the light guide as discussed above, or they may not be bonded to each other. In some cases, the dual-sided optical film may be packaged, sold, or used with both a light guide that is tailored for use with the dual-sided film, and one or more LED(s) or other light source(s) that are adapted to inject light into the light guide, e.g., from opposite ends thereof as shown generally in FIG. 1A. The dual-sided film, the light guide, and the light source(s) may be bonded, attached, or otherwise held in proximity to each other to form a lighting module, which may be large or small, rigid or flexible, and substantially flat/planar or non-flat/non-planar, and which may be used by itself or in combination with other components. A lighting system that includes a dual-sided optical film, a light guide, and one or more light source(s) may be adapted for any desired end use, e.g., a display, a backlight, a luminaire, a task light, static backlit signs, or a general-purpose lighting module.

FIG. 2 shows a schematic perspective view of an exemplary light guide 250 that may be suitable for use with some or all of the disclosed dual-sided optical films. The light guide 250 may be substituted for the light guide 150 in FIG. 1A, and the properties, options, and alternatives discussed in connection with the light guide 150 will be understood to apply equally to the light guide 250. Cartesian x-y-z coordinates are provided in FIG. 2 in a manner consistent with the coordinates of FIGS. 1A and 1B. FIG. 2 shows in exaggerated fashion exemplary surface structure on the two major surfaces of the light guide 250, but other orientations of the structured surface(s) relative to the edges or boundaries of the light guide can be used. The light guide 250 includes a first major surface 250a from which light is extracted towards a dual-sided optical film, a second major surface 250b opposite the first major surface, and side surfaces 250d, 250c which may serve as light injection surfaces for the first and second light sources as discussed elsewhere herein. For example, one light source may be positioned along the side surface 250c to provide a first oblique light beam emitted from the light guide 250, and a similar light source can be positioned along the side surface 250d to provide a second oblique light beam emitted from the light guide 250. An oblique light beam in this regard refers to a light beam whose intensity distribution in the x-z plane has a peak intensity direction of 60 degrees or more, or 70 degrees or more, or 80 degrees or more relative to the surface normal (z-axis), as discussed above.

The rear major surface 250b of the light guide is preferably machined, molded, or otherwise formed to provide a linear array of shallow prism structures 252. These prism structures are elongated along axes parallel to the y-axis, and are designed to reflect an appropriate portion of the light propagating along the length of the light guide (along the x-axis) so that the reflected light can refract out of the front major surface 250a into air (or a tangible material of suitably low refractive index) at a suitably oblique angle, and onward to the dual-sided optical film. In many cases, it is desirable for the reflected light to be extracted from the front major surface 250a relatively uniformly along the length of the light guide 250. The surface 250b may be coated with a reflective film such as aluminum, or it may have no such reflective coating. In the absence of any such reflective coating, a separate back reflector may be provided proximate the surface 250b to reflect any downward-propagating light that passes through the light guide so that such light is reflected back into and through the light guide. The prism structures 252 typically have a depth that is shallow relative to the overall thickness of the light guide, and a width or pitch that is small relative to the length of the light guide. The prism structures 252 have apex angles that are typically much greater than the apex angles of prisms used in the disclosed dual-sided optical films. The light guide may be made of any transparent optical material, typically with low scattering such as polycarbonate, or an acrylic polymer such as Spartech Polycast material. In one exemplary embodiment, the light guide may be made of acrylic material, such as cell-cast acrylic, and may have an overall thickness of 1.4 mm and a length of 140 mm along the x-axis, and the prisms may have a depth of 2.9 micrometers and a width of 81.6 micrometers, corresponding to a prism apex angle of about 172 degrees. The reader will understand that these values are merely exemplary, and should not be construed as unduly limiting.

The front major surface 250a of the light guide may be machined, molded, or otherwise formed to provide a linear array of lenticular structures or features 254 that are parallel to each other and to a lenticular elongation axis. In contrast to the elongation axis of the prism structures 252, the lenticular elongation axis is typically parallel to the x-axis. The lenticular structures 254 may be shaped and oriented to enhance angular spreading in the y-z plane for light that passes out of the light guide through the front major surface, and, if desired, to limit spatial spreading along the y-axis for light that remains in the light guide by reflection from the front major surface. In some cases, the lenticular structures 254 may have a depth that is shallow relative to the overall thickness of the light guide, and a width or pitch that is small relative to the width of the light guide. In some cases, the lenticular structures may be relatively strongly curved, while in other cases they may be more weakly curved. In one embodiment, the light guide may be made of cell-cast acrylic and may have an overall thickness of 0.76 mm, a length of 141 mm along the x-axis, and a width of 66 mm along the y-axis, and the lenticular structures 254 may each have a radius of 35.6 micrometers, a depth of 32.8 micrometers, and a width 323 of 72.6 mm, for example. In this embodiment, the prism structures 252 may have a depth of 2.9 micrometers, a width of 81.6 micrometers, and a prism apex angle of about 172 degrees. Again, the reader will understand that these embodiments are merely exemplary, and should not be construed as unduly limiting; for example, structures other than lenticular structures may be used on the front major surface of the light guide.

As mentioned above, the lenticular structures 254 may be shaped and oriented to limit spatial spreading along the y-axis for light that remains in the light guide by reflection from the front major surface. Limited spatial spreading along the y-axis can also be achieved, or enhanced, with light sources that are collimated (including substantially collimated) in the plane of the light guide, i.e., the x-y plane. Such a light source may be a relatively small area LED die or dies in combination with one or more collimating lenses, mirrors, or the like. FIG. 2A shows the light guide 250 of FIG. 2 in combination with light sources 232a, 232b, 232c arranged along side surface 250d, and light sources 234a, 234b, 234c arranged along side surface 250c. These light sources may be substantially collimated, or the lenticular structures 254 may be shaped to limit spatial spreading of light along the y-axis, or both. In the figure, the light sources 232a, 232b, 232c are shown as being ON, and the other light sources are OFF. Due to the collimation of the light sources, the shape of the lenticular structures 254, or both, the light sources 232a, 232b, 232c illuminate respective stripes or bands 250-1, 250-2, 250-3 of the light guide 250. The bands may be distinct, with little or no overlap as shown in the figure, or they may overlap to some extent. Each of the light sources may be independently addressable, such that the light guide can be effectively subdivided or partitioned as a function of which light sources on each side of the light guide are turned ON. For example, only one of the bands 250-1, 250-2, 250-3 may be illuminated, or only two may be illuminated, or all of the bands may be illuminated. Light sources 234a, 234b, 234c, which are located on the opposite side of the light guide, may be aligned with their counterpart light sources at side surface 250d such that they illuminate the same respective bands 250-1, 250-2, 250-3; alternately, the light sources 234a, 234b, 234c may be shifted or staggered along the y-direction relative to the light sources at side surface 250d, such that they illuminate other bands which may or may not overlap with each other in similar fashion to bands 250-1, 250-2, 250-3. The light sources 232a, 232b, 232c, 234a, 234b, 234c may all emit white light, or light of a non-white color or wavelength, or the light sources may emit different colors. A given portion of the light guide 250, such as any of the bands 250-1, 250-2, 250-3, may thus function as an independent light guide, and may emit at least two different output beams as a function of whether only its associated light source(s) at one side surface (e.g. surface 250d) is ON, or whether only its associated light source(s) at the opposite side surface (e.g. surface 250c) is ON, or whether both such light sources are ON. When a dual-sided optical film is used with such a light guide, the spatially banded or striped output capability of the light guide is substantially transferred to the dual-sided optical film, such that, by energizing the appropriate light source(s), the disclosed light outputs (including e.g. groups of angularly separated light beams) can emerge from the dual-sided optical film over all (all stripes or bands), or only a portion (at least one but less than all stripes or bands), or none (no stripes or bands) of its output surface.

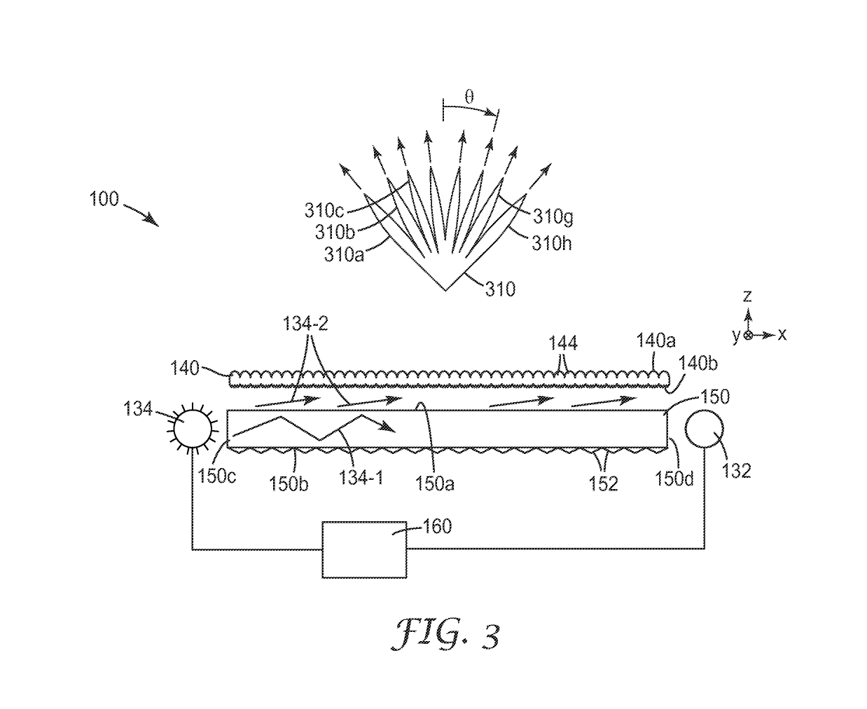

Turning now to FIG. 3, we see there another schematic side view of the lighting system 100 of FIG. 1A. In FIG. 3, only the light source 134 is energized (ON), and the light source 132 is not energized (OFF). Due to the characteristics of the light guide 150, the characteristics of the optical film 140, and the interaction between the light guide and the optical film, light from the light source 134 produces a first film light output 310 emerging from the dual-sided optical film. The reader will understand that although the light output 310 is drawn above a central portion of the film 140, we assume for this particular embodiment that this same light output is emitted from substantially the entire first structured surface 140a. The light output 310 has an angular distribution in the x-z plane characterized by a group of closely spaced (as a function of angle θ) but angularly separated lobes 310a, 310b, . . . , 310h. The outermost lobes 310a, 310h define sharp transitions at the outer opposite edges or sides of the generally fan-shaped light output 310. Between those outer edges, the brightness of the output 310 fluctuates rapidly and substantially as a function of angle to define the eight distinct lobes 310a, 310b, 310c, etc. Depending upon the amount of fluctuation between the lobe peaks and the relative minima between lobes, some or all of the lobes may be considered to be separate light beams, as discussed below. The number N of distinct lobes or beams, in this case N=8, may be equal to the number of individual prisms in each of the prism clusters on the structured surface 140b, as discussed further below.

Light from the energized light source 134 enters the light guide 150 through the first side 150c. This light travels along the light guide 150 generally in the positive x-direction, the light reflecting from the major surfaces 150a, 150b to provide a first guided light beam 134-1. As the beam 134-1 propagates, some of the light is refracted or otherwise extracted from the major surface 150a to provide an oblique light beam 134-2, represented by obliquely oriented arrows representing a direction of maximum light intensity in the x-z plane. The oblique light beam 134-2 is typically emitted over substantially the entire surface area of the major surface 150a, i.e., not only in the geometric center of the major surface 150a but also at or near its edges and at intermediate positions in between, as indicated by the multiple oblique arrows. The oblique light beam 134-2 has a direction of maximum light intensity that is most closely aligned with the positive x-direction. The direction of maximum light intensity of the beam 134-2 may deviate from the positive x-direction by, for example, 30 degrees or less, or 20 degrees or less, or 15 degrees or less, or 10 degrees or less.

Because of the directionality of the oblique light beam 134-2, light from the light source 134 may enter the dual-sided optical film 140 predominantly through only one inclined side surface of each of the prisms on the second structured surface 140b of the film 140. Refraction provided at such inclined surfaces, in cooperation with reflection provided at other inclined surfaces of the prisms, and in cooperation with refraction provided by the lenslets 144, causes light to emerge from the film 140 as the first film light output 310. The first film light output 310 arises from the summation of individual light outputs emitted from each lenslet 144 across the film 140, which individual outputs are referred to as lenslet light outputs. For simplicity, we assume that the film 140 is configured such that the individual lenslet light outputs have angular distributions that are the same as each other, and the same as that of the film light output 310. In other embodiments, the angular distributions of the individual lenslet light outputs may differ from each other, and which would then sum together to provide an overall film light output that has a different angular distribution from that of the individual lenslet light outputs.

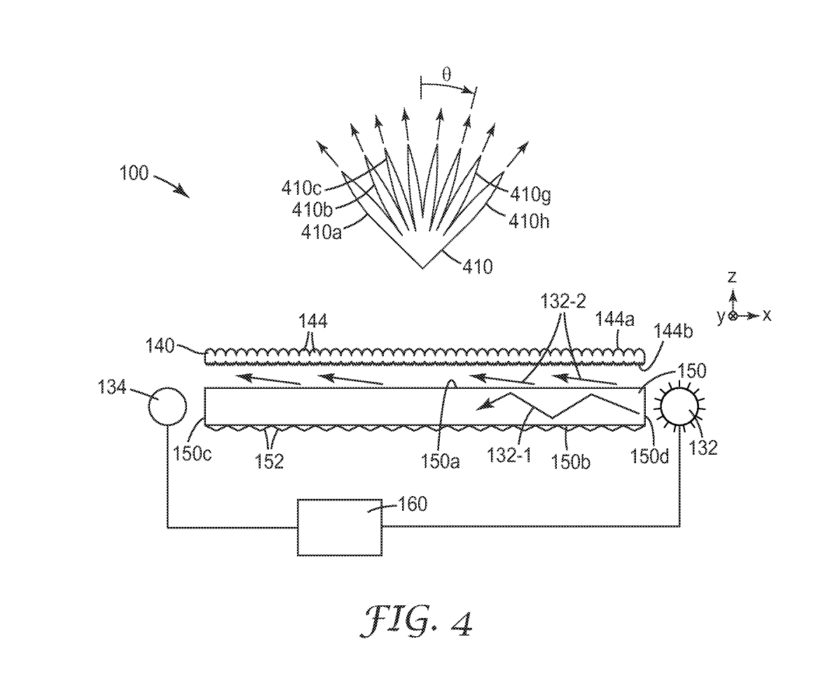

If the first light source 134 is turned OFF and the second light source 132 is turned ON, the system 100 produces a second film light output, which is also characterized by a generally fan-shaped angular distribution in the x-z plane which is or includes a group of closely spaced (as a function of angle θ) but angularly separated lobes, the outermost lobes defining sharp transitions at the outer opposite edges or sides of the light output. Depending upon the amount of fluctuation between the lobe peaks and the relative minima between lobes, some or all of the lobes may be considered to be separate light beams. The second film light output typically covers an angular range that differs from that of the first film light output, but the angular distributions of these two film light outputs typically overlap, whether or not any of their respective individual lobes (or beams) overlap. FIG. 4 shows a typical second film light output 410 that may be produced in a manner consistent with the first film light output 310 of FIG. 3, with the same dual-sided optical film 140.

Thus, in FIG. 4, the lighting system 100 is shown again, except that the light source 134 is not energized (OFF), and the light source 132 is energized (ON). Due to the characteristics of the light guide 150, the characteristics of the dual-sided optical film 140, and the interaction between the light guide and the optical film, light from the light source 132 produces a second film light output 410 emerging from the optical film, the second film light output 410 having an angular distribution that is typically different from the first film light output 310 of FIG. 3.

Light from the energized light source 132 enters the light guide 150 through the second side 150d. This light travels along the light guide 150 generally in the negative x-direction, the light reflecting from the major surfaces 150a, 150b to provide a first guided light beam 132-1. As the beam 132-1 propagates, some of the light is refracted or otherwise extracted from the major surface 150a to provide an oblique light beam 132-2, represented by obliquely oriented arrows representing a direction of maximum light intensity in the x-z plane. The oblique light beam 132-2 is typically emitted over substantially the entire surface area of the major surface 150a, i.e., not only in the geometric center of the major surface 150a but also at or near its edges and at intermediate positions in between, as indicated by the multiple oblique arrows. The oblique light beam 132-2 has a direction of maximum light intensity that is most closely aligned with the negative x-direction. The direction of maximum light intensity of the beam 132-2 may deviate from the negative x-direction by, for example, 30 degrees or less, or 20 degrees or less, or 15 degrees or less, or 10 degrees or less.

Because of the directionality of the oblique light beam 132-2, light from the light source 132 may enter the dual-sided optical film 140 predominantly through only a second inclined side surface of each of the prisms on the second structured surface 140b of the film 140, this second inclined surface being the opposite of the inclined surface used in connection with FIG. 3. Refraction provided at such inclined surfaces, in cooperation with reflection provided at other inclined surfaces of the prisms, and in cooperation with refraction provided by the lenslets 144, causes light to emerge from the film 140 as the second film light output 410. The second film light output 410 arises from the summation of individual light outputs emitted from each lenslet 144 across the film 140, which individual outputs are referred to as lenslet light outputs. For simplicity, we assume that the film 140 is configured such that the individual lenslet light outputs have angular distributions that are the same as each other and as that of the second film light output 410. In other embodiments, the angular distributions of the individual lenslet light outputs may differ from each other, and which would then sum together to provide an overall film light output that is different from each of the lenslet light outputs.

We will now discuss design details of exemplary dual-sided optical films that allow the films to produce light outputs, such as those shown in FIGS. 3 and 4, whose angular distributions in a particular plane of observation have sharp transitions or edges on opposite sides or edges of the distribution, and which fluctuate rapidly and substantially as a function of angle to define the distinct light lobes, or beams. In general, such films have opposed first and second structured surfaces, the first structured surface having a plurality of extended lenslets formed therein, and the second structured surface having a plurality of extended prisms formed therein. The prisms are grouped into clusters of adjacent prisms, the clusters being separated from each other, with each prism cluster having at least three individual prisms. The lenslets and prism clusters are arranged in a one-to-one correspondence of lenslets to prism clusters. Most, or substantially all, of the individual prisms have a sharp vertex, formed by the tip portions of their inclined side surfaces. The films are configured such that the prism vertices for a given prism cluster are located at or near a focal surface of the associated lenslet. For example, a focal space may be defined as a space that encompasses the focal surface and has boundaries that are separated from the focal surface by a differential distance DD equal to 20% of the axial focal length of the lenslet, and the prism vertices of the prisms in the prism cluster associated with the lenslet are disposed in the focal space of the lenslet.

The structured surfaces of the films can be made using any known microreplication techniques, e.g. by embossing or thermoforming a polymer film, or using continuous cast-and-cure methods. In the latter case, a curable polymer material or polymer precursor material may be applied between a transparent carrier film and a suitably configured structured surface tool. The material is then cured and separated from the tool to provide a layer that is bonded to the carrier film and has the desired microstructured topography. One such layer can be applied on one side of the carrier film to form the lenslets (see e.g. the first structured surface 140a in FIG. 3), and another such layer can be applied on the opposite side of the carrier film to form the prisms and prism clusters (see e.g. the second structured surface 140b in FIG. 3). To the extent microreplication techniques are used in the fabrication of the film, they are desirably employed in such a manner that the relative positions of elements on opposite structured surfaces of the film, e.g. a given lenslet and a given prism, may be controlled, and so that the axial distance between them can also be controlled e.g. by appropriate selection of film thicknesses and coating thicknesses. Reference is made to patent application publication US 2005/0052750 (King et al.), which describes among other things how microreplicated structures can be made in alignment on opposite sides of an article. The dual-sided optical films may be made using a carrier film made from polyethylene terephthalate (PET), polycarbonate, or any other suitable light-transmissive polymer(s) or other material(s).

The structured surfaces of the disclosed dual-sided optical films, as well as the structured surfaces of the disclosed light guides, can alternatively or in addition be made using known additive manufacturing techniques, sometimes referred to as three-dimensional printing or 3D printing.

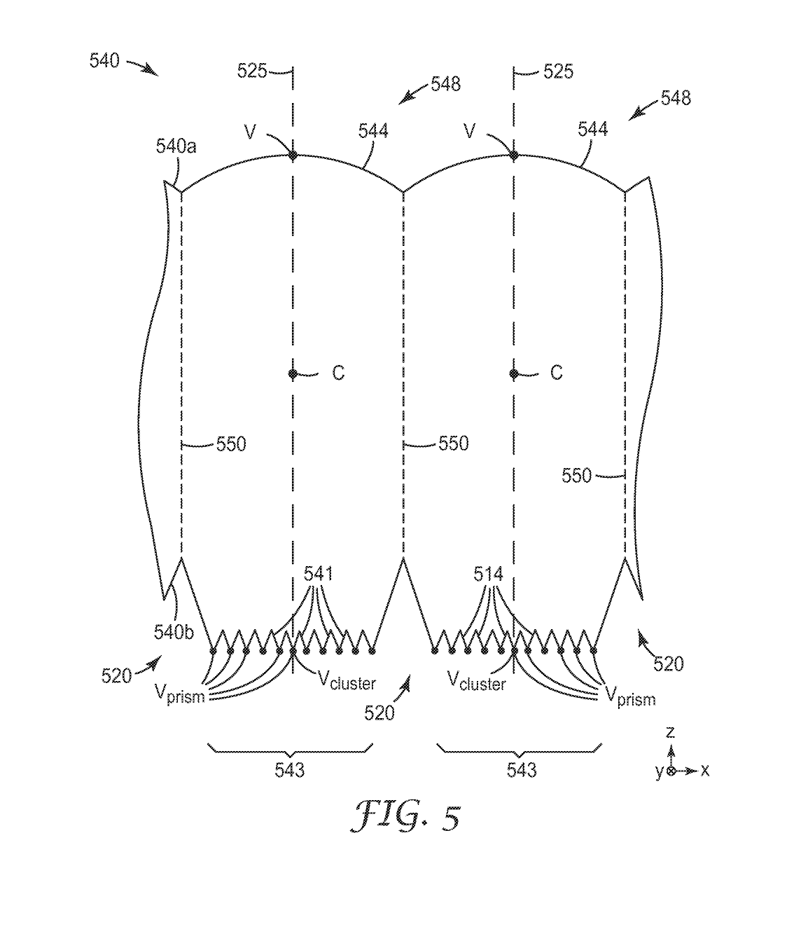

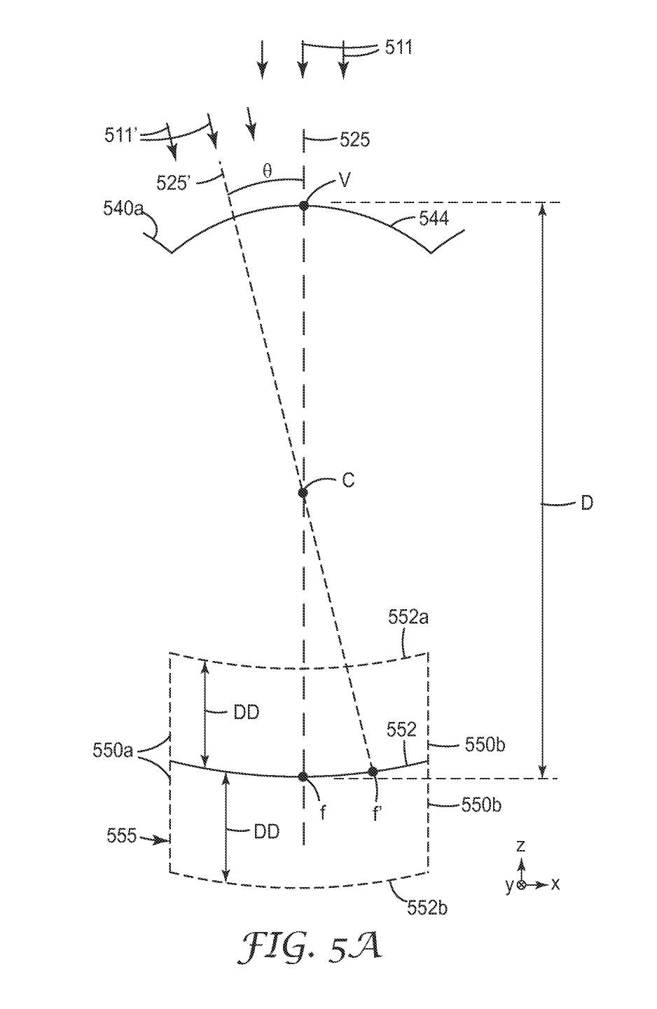

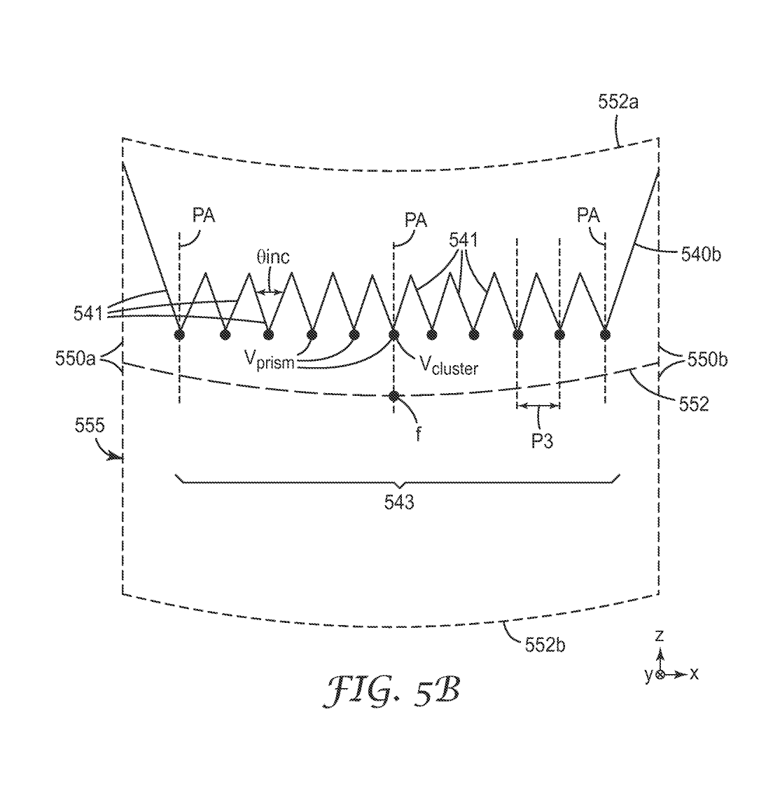

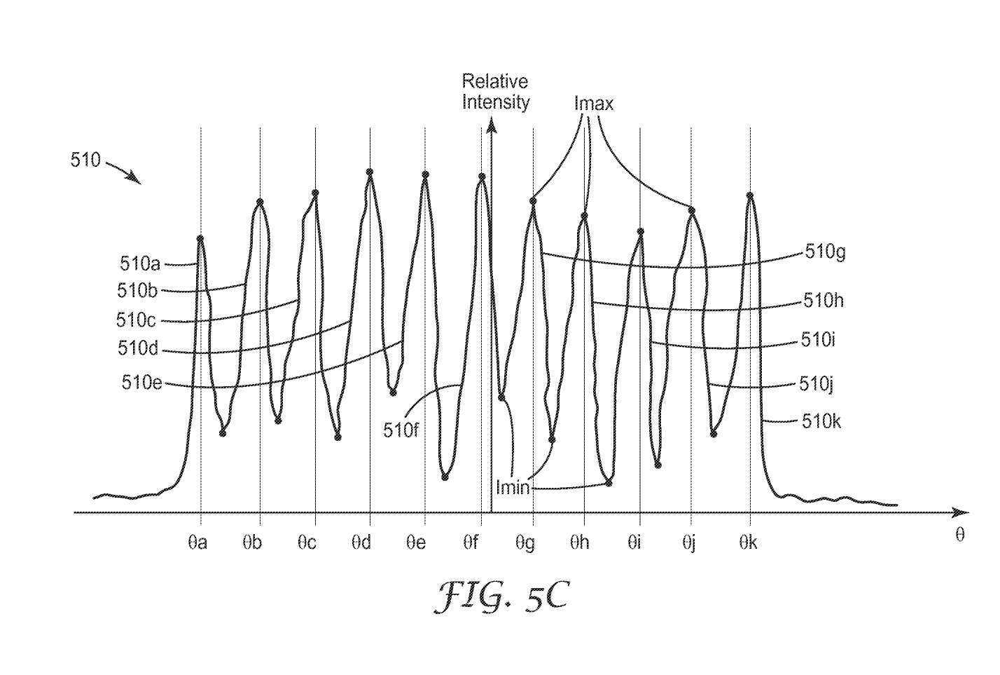

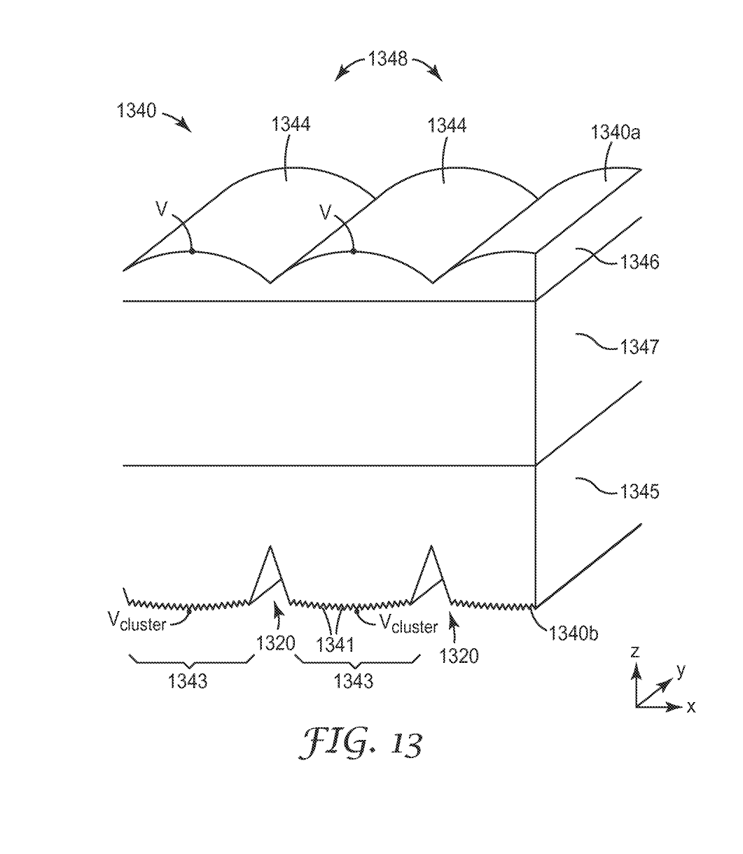

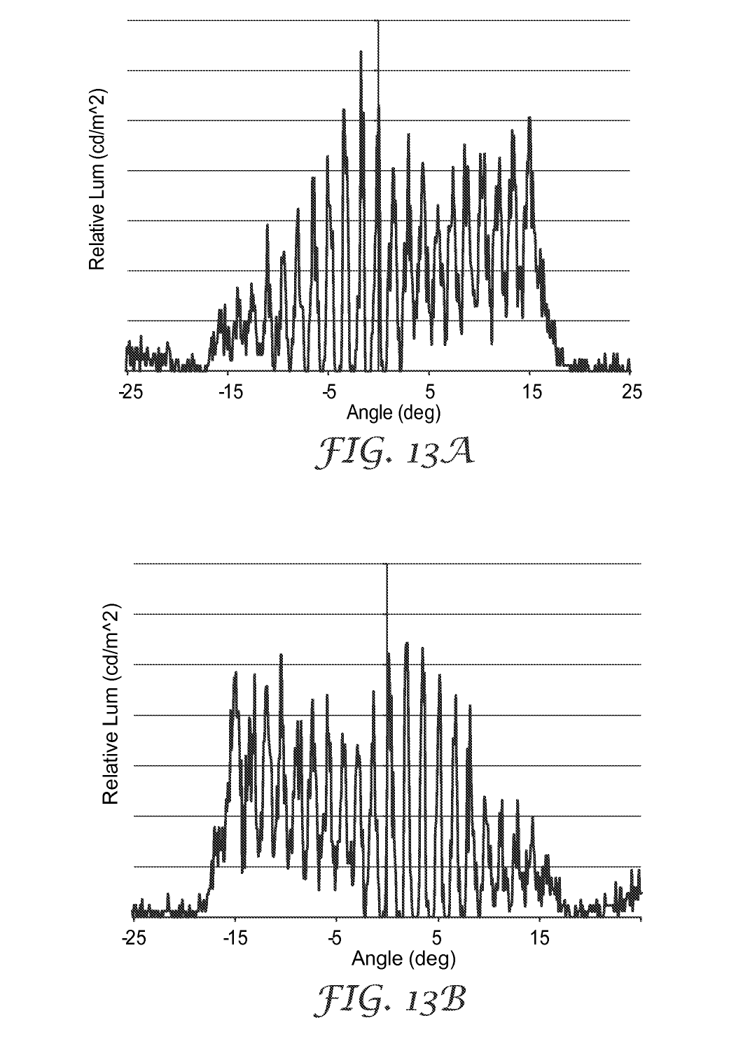

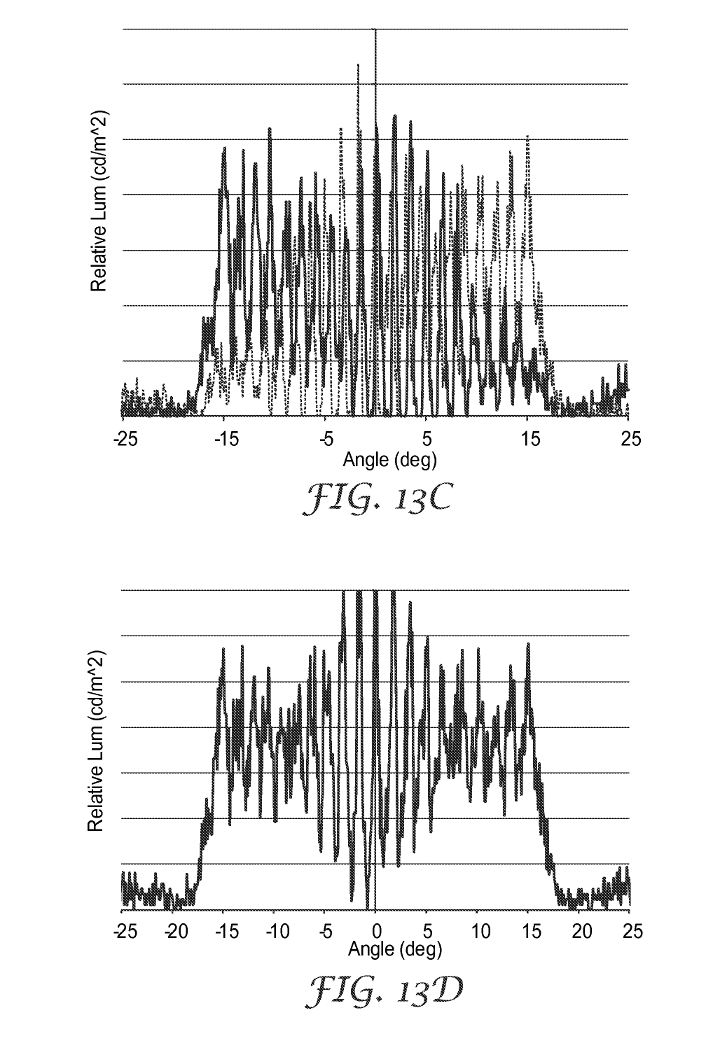

FIG. 5 is a schematic view of a portion of one exemplary dual-sided optical film 540. This film has opposed first and second structured surfaces 540a, 540b. Although the film 540 is shown to have the construction of a single layer of material, which in use would typically be immersed in air or vacuum, or attached at one or both major surfaces to other components, other film constructions are also contemplated. For example, the film 540 may have a central carrier film to which other material layers are attached, as shown below e.g. in FIG. 13. The film 540 is shown in relation to a Cartesian x-y-z coordinate system which is consistent with the coordinates in the previous figures. Thus, the film 540 lies in or defines a film plane generally parallel to the x-y plane, and has a thickness axis parallel to the z-axis.

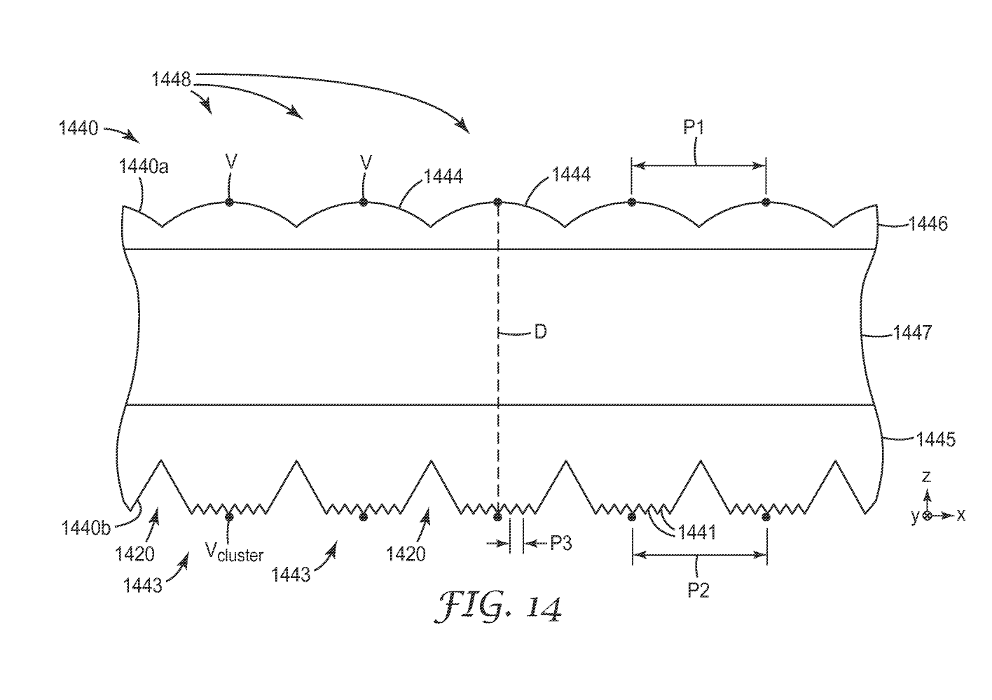

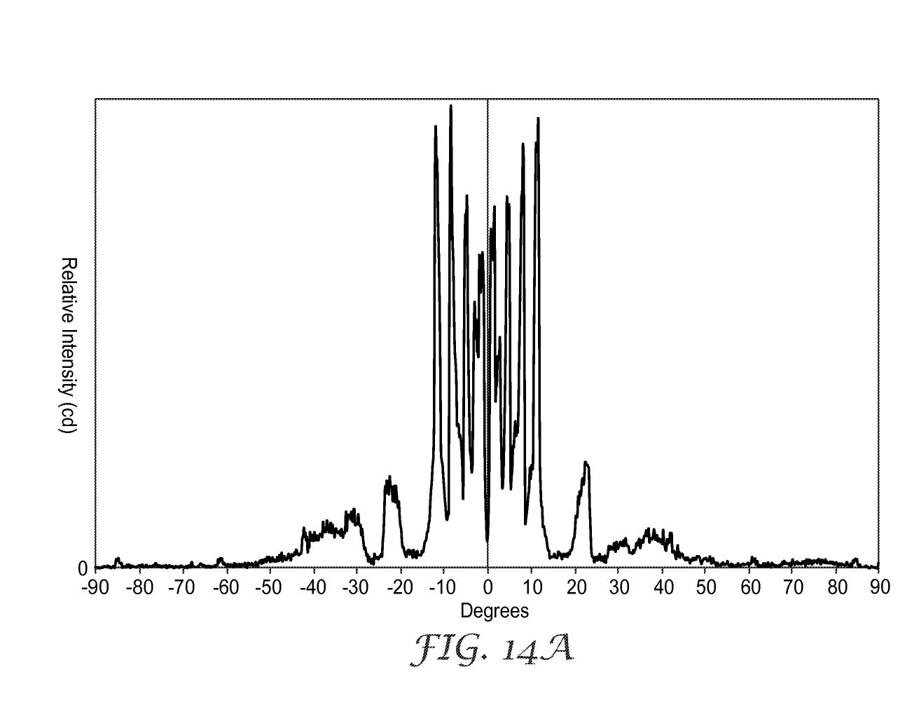

The first structured surface 540a has a plurality of lenslets 544 formed therein. Each of these lenslets 544 extends along an elongation axis that is parallel to the y-axis. The lenslets 544 may have a single, uniform curvature, i.e. the curved surface of each lenslet may be a portion of a right circular cylinder, or they may have a non-uniform curvature, e.g., a continuously variable curvature with a smaller radius of curvature in a central portion and greater radius of curvature near the edges, or vice versa. A lenslet that has a non-uniform curvature is said to have a compound curvature. Each lenslet 544 also has a vertex, labeled V. Whether the lenslet 544 has a compound curvature or a simple (uniform) curvature, the curvature of the lenslet 544 at its vertex V may be characterized by a center of curvature, which is labeled C in FIG. 5. Note that the vertex V and the center of curvature C for each lenslet 544 lie on an axis 525, discussed further below. The vertex V and the center of curvature C for each lenslet 544 may thus be said to lie along an axial direction 525. In the embodiment of FIG. 5, the axis 525 is parallel to the z-axis and to the thickness axis of the film 540. Another characteristic feature of each lenslet 544 is the focal point of the lenslet, which is also related to a focal surface and focal space of the lenslet. To avoid excessive clutter, these features of the lenslet 544 are omitted from FIG. 5, but are shown below in FIG. 5A. The lenslets 544 may collectively be characterized by a pitch P1, as shown e.g. in FIG. 14 below. The pitch may be measured center-to-center (e.g. vertex-to-vertex), or from edge-to-edge of adjacent lenslets. The pitch is typically uniform over the extent of the structured surface 540a, but in some cases it may not be uniform.

The second structured surface 540b has a plurality of prisms 541 formed therein. Similar to the lenslets 544, the prisms 541 each extend along an elongation axis parallel to the y-axis. Each prism 541 has two inclined side surfaces, which meet at a sharp peak or vertex of the prism, labeled Vprism. The included angle of each prism 541 at its vertex, referred to as a vertex angle, is typically in a range from 50 to 90 degrees, e.g., 63.5 degrees, but this should not be construed as unduly limiting. Regardless of the vertex angle, the vertex is desirably sharp rather than truncated or rounded, e.g., having a radius of curvature of no more than 3 microns, or no more than 2 microns, or no more than 1 micron, or less. The prism vertex may in this regard be described as dead sharp. The prisms 541 do not occupy the entire second structured surface 540b, but are organized into groups or clusters 543 of adjacent prisms 541, which clusters 543 are separated from each other by one or more features that do not include elongated prisms. In the embodiment of FIG. 5, the clusters 543 are separated from each other on the structured surface 540b by large individual V-grooves 520.

There is a one-to-one correspondence of lenslets 544 to prism clusters 543. For a given lenslet 544, one of the prism clusters 543 predominantly interacts optically with (and typically is closest to) the lenslet, thus, the lenslet 544 and the prism cluster 543 associated with it in this manner can be said to form a lenslet/prism cluster pair 548. Two such complete pairs 548 are shown in FIG. 5. Boundaries between adjacent pairs 548 are labeled 550 in FIG. 5. Typically, the boundaries 550 do not represent any physical structure, interface, or barrier, thus, light rays traveling through the film 540 may propagate freely from one lenslet/prism cluster pair 548 to the next.

In describing the configuration and design of the disclosed dual-sided films, it is useful to assign to each prism cluster a representative feature that is located centrally within the group of individual prisms that make up the cluster. The most relevant such representative feature is the prism vertex Vprism for the prism that is centrally located within the prism cluster, e.g., equal numbers of the remaining prisms in the cluster are located on opposite sides of the central prism. If no prism is centrally located, the representative feature of the cluster can be taken to be the prism vertex Vprism for the prism that is most nearly centrally located within the prism cluster. In the embodiment of FIG. 5, there are 11 prisms 541 in each prism cluster 543, thus, a centrally located prism exists, and the prism axis Vprism of this prism is also labeled Vcluster for each of the prism clusters 543. Other numbers N of prisms 541 may be used in alternative embodiments, e.g., N=3, or 5, or 10 or more. We refer to the axis Vcluster as the central vertex for the cluster of prisms, or, in short, the cluster vertex. When defined in a consistent manner for all the prism clusters in the film, the cluster vertex Vcluster can be used to characterize the position of the cluster with respect to its associated lenslet, and with respect to other prism clusters. The positions of prism clusters with respect to each other may be characterized by a pitch P2, as shown e.g. in FIG. 14 below. The pitch may be measured from cluster vertex to cluster vertex of adjacent prism clusters 543. The pitch is typically uniform over the extent of the structured surface 540b, but in some cases it may not be uniform. The pitch P2 may equal P1, whereupon the degree of registration of the lenslets 544 to the prism clusters 543 remains constant or substantially constant over the relevant area of the film 540 along the x-axis. Alternatively, P2 may be slightly greater than or less than P1, whereupon the degree of registration of the lenslets 544 to the prisms 541 changes over the relevant area of the film 540 along the x-axis. The positions of prism clusters with respect to their associated lenslets on the opposite structured surface 540a may be characterized, for each lenslet/prism cluster pair 548, by an optical axis that connects the central feature of the lenslet 548, e.g. the lenslet vertex V, with the central feature of its associated prism cluster, e.g. the cluster vertex Vcluster. Such optical axes were introduced above and are labeled 525 in FIG. 5.

Turning now to FIG. 5A, we see there in isolation a portion of the structured surface 540a from FIG. 5, showing a representative lenslet 544. The lenslet 544 has a vertex V, a center of curvature C, and an optical axis 525 as discussed above. The lenslet 544 also has a focal point 1. The focal point f can be defined in terms of collimated light 511 whose propagation direction is parallel to the optical axis 525. In particular, and notwithstanding or ignoring aberrations, the lenslet 544 focuses such light 511 to the focal point 1. If we then consider the interaction between the lenslet 544 and collimated light that propagates over a range of other directions, we see that the focal point f is one point on a focal surface of the lenslet 544. For example, collimated light 511′ has a propagation direction that is parallel to the axis 525′, which is rotated or tilted by an angle θ relative to the axis 525. The lenslet 544 focuses such light 511′ to a new point, labeled f. By sweeping the angle θ over a range that encompasses the limits of the lenslet 544, the locus of all points f define a focal surface 552. The focal surface 552 includes the focal point f at the intersection of the focal surface 552 with the optical axis 525.

It is useful to define, for each lenslet 544, a region of space or volume in proximity to the focal surface 552 of the lenslet, which we refer to as a focal space. We begin by identifying the axial focal length of the lenslet 544, which is measured from the vertex V of the lenslet to the focal point f along the optical axis 525. This axial focal length is labeled D in FIG. 5A. We can then use a fraction of this distance as a standard by which to describe the boundaries of the focal space with respect to the focal surface 552. Specifically, we define a differential distance DD to equal 20% of D, and we define a surface 552a to be the same as the focal surface 552 but translated along the optical axis 525 towards the lenslet 544 by the distance DD, and we also define a surface 552b to be the same as the focal surface 552 but translated along the optical axis 525 away from the lenslet 544 by the distance DD. Lateral surfaces 550a, 550b are defined as extensions of the boundaries 550 (see FIG. 5) between lenslet/prism cluster pairs 548 that connect the surface 552a to surface 552b so as to form a closed volume. The resulting focal space 555 for the lenslet 544 encompasses the lenslet's focal surface 552, and is bounded by the surfaces 552a, 552b, 550a, and 550b.

An enlarged view of this focal space 555 is shown in FIG. 5B, together with the prism cluster 543 which is associated with the lenslet 544. In order to provide sharp edges or transitions in the angular distribution of the light output of the lenslet and/or the film, the vertices Vprism of the prisms 541 in the prism cluster 543 are disposed at or near the focal surface 552. One measure of being disposed near the focal surface is to specify that the vertex or vertices in question are disposed in the focal space 555 described above. Thus, as seen in FIG. 5B, all of the prism vertices Vprism in the cluster 543 are disposed in the focal space 555. In this particular embodiment, the prism vertices are coplanar, and because the focal surface 552 is non-planar, the vertices Vprism are at a variety of distances from the focal surface 552. If desired, the overall thickness of the film 540 may be increased or decreased to shift the prism cluster 543 away from the lenslet 544 (and closer to the surface 552b) or towards the lenslet 544 (and closer to the surface 552a), respectively, while ensuring that the vertices Vprism all remain within the focal space 555. In order to maintain sharp edges in the angular distribution of the light output while reducing the amount of fluctuation between output lobes (e.g. to try to achieve an angular distribution that most closely approximates a flat “top hat” distribution in a plot of intensity versus angle, which top hat distribution may also fall within the broader category of a fan-shaped distribution), while also keeping the film thickness small for reduced material costs and improved flexibility and reduced stiffness, it can be desirable in some circumstances to control the design parameters of the film such as film thickness, lenslet curvature, refractive indices, etc., so that some or all of the vertices Vprism are disposed in the portion of the focal space between the focal surface and the lenslet, i.e., in the region between surfaces 552, 552a, 550a, and 550b.

Due to the enlarged view of FIG. 5B, some details of the prisms are shown that were not shown in FIG. 5. In particular, each prism 541 has an included angle θinc, i.e. a vertex angle, between its inclined side surfaces forming the vertex Vprism. In typical embodiments, the vertex angle for all the prisms in the cluster 543, as well as for the prisms of other prism clusters on the second structured surface, is the same. As mentioned above, this angle is typically in a range from 50 to 90 degrees, e.g., 63.5 degrees. Bisecting each vertex angle θinc is a prism axis PA. The prism axis PA can thus be considered to be an optical axis of a given prism 541. In the embodiment of FIGS. 5 and 5B, prism axes PA are all parallel to the thickness axis of the film, and to the optical axis 525 of the lenslet/prism cluster pair. The prisms 541 may be uniformly spaced along the x-axis according to a prism pitch P3 between adjacent prism vertices Vprism.

FIG. 5C is an idealized graph of a hypothetical lenslet light output 510 defining N angularly separated lobes or beams that may be produced when oblique light illuminates the second structured surface of the film of FIG. 5. Since we do not specify the nature of the oblique light, it may be one-sided oblique light, e.g., originating from a first light source on one side of the light guide (e.g. light source 134 in FIG. 1A) or from a second light source on the opposite side of the light guide (e.g. light source 132 in FIG. 1A), but not both, or it may be two-sided, e.g., originating from both the first and second light sources. In any case, the output 510 fluctuates in relative intensity as a function of the angle θ (measured e.g. in the x-z plane relative to the z-axis) to produce an alternating sequence of relative maxima Imax and relative minima Imin. These maxima and minima define eleven lobes 510a, 510b, . . . 510k. The outermost lobes 510a, 510k have outermost edges or transitions that can be considered to be outer edges or sides of the light output 510, which (when plotted in the x-y plane) is a fan-shaped distribution. Depending on the amount of fluctuation between the relative maxima Imax and the relative minima Imin between adjacent maxima, some or all of the lobes 510a, 510b, etc. may be considered to be separate light beams. For purposes of this application, two adjacent lobes in the angular distribution of a light output are considered to be distinct and separate light beams if the relative minima Imin between such lobes is less than half of the smaller of the two relative maxima Imax for such lobes. If the relative minima Imin between two adjacent lobes is 50% or more of the smaller of the two relative maxima Imax for such lobes, the lobes are considered to be part of a single beam rather than separate beams. Note that this condition for separate light beams is given with regard to the angular distribution, rather than the spatial distribution, of the light output. For this reason, light beams that are distinct using this test may nevertheless overlap spatially with each other, particularly at positions or in observation planes that are close to the dual-sided optical film. In the particular hypothetical light output 510 depicted in FIG. 5C, the relative minima and relative maxima are shown such that the N lobes (N=11) 510a, 510b, etc. are considered to be N separate light beams.

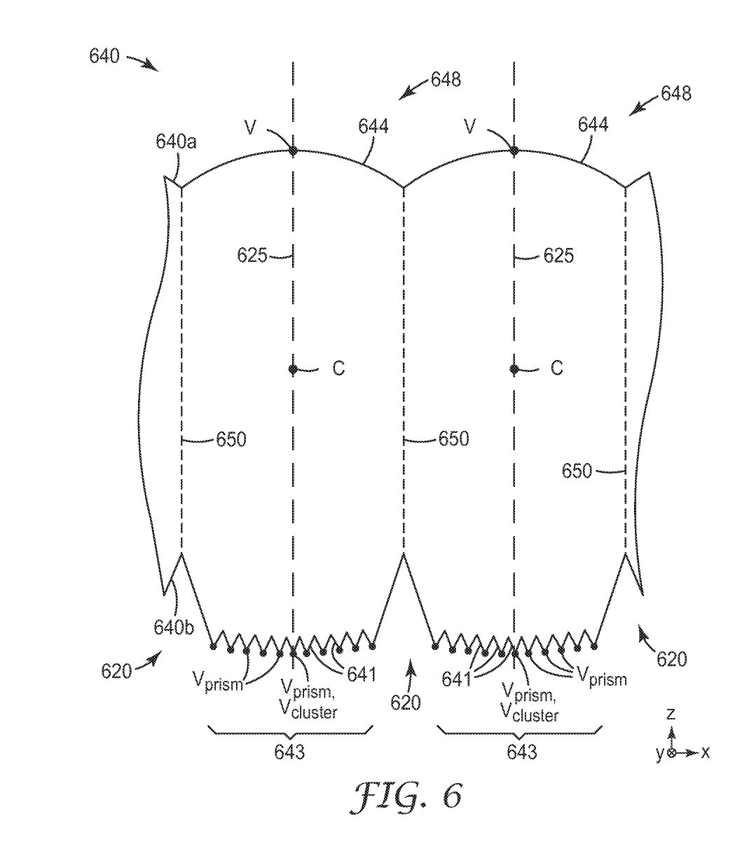

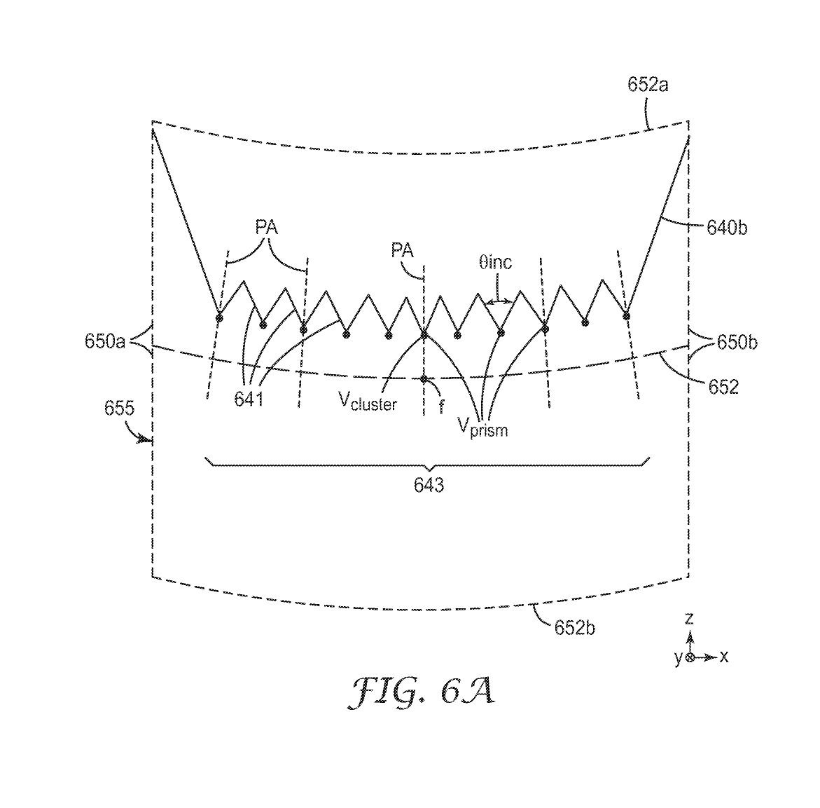

Turning now to FIG. 6, we see there a schematic side or sectional view of a portion of a dual-sided optical film 640 similar to the film 540 of FIG. 5, but where the prism vertices in each cluster of prisms are non-coplanar. The film 640 has opposed first and second structured surfaces 640a, 640b. The film 640 is shown to have the construction of a single layer of material, but other film constructions are also contemplated as discussed elsewhere herein. The film 640 is shown in relation to a Cartesian x-y-z coordinate system which is consistent with the coordinates in the previous figures.

The first structured surface 640a has a plurality of lenslets 644 formed therein. Each lenslet 644 extends along an elongation axis that is parallel to the y-axis. The lenslets 644 may have a single, uniform curvature, or they may have a compound curvature. Each lenslet 644 also has a vertex V. The curvature of the lenslet 644 at its vertex V may be characterized by a center of curvature, labeled C. The vertex V and the center of curvature C for each lenslet 644 lie on an axis 625, similar to the axis 525 from FIG. 5. The axis 625 is parallel to the z-axis and to the thickness axis of the film 640. Another characteristic feature of each lenslet 644 is the focal point of the lenslet, which is also related to a focal surface and focal space of the lenslet as discussed above in connection with FIG. 5A. The lenslets 644 may collectively be characterized by a pitch P1 (see e.g. FIG. 14), which is typically uniform over the extent of the structured surface 640a, but in some cases it may not be uniform.

The second structured surface 640b has a plurality of prisms 641 formed therein. Similar to the lenslets 644, the prisms 641 each extend along an elongation axis parallel to the y-axis. Each prism 641 has two inclined side surfaces, which meet at a sharp peak or vertex Vprism. Details of the prism vertices are discussed elsewhere herein.

The prisms 641 are organized into groups or clusters 643 of adjacent prisms 641, which are separated from each other by one or more features that do not include elongated prisms. In the embodiment of FIG. 6, the clusters 643 are separated from each other on the structured surface 640b by large individual V-grooves 620. There is a one-to-one correspondence of lenslets 644 to prism clusters 643. For a given lenslet 644, one of the prism clusters 643 predominantly interacts optically with and is typically closest to the lenslet, thus, the lenslet 644 and the prism cluster 643 associated with it in this manner can be said to form a lenslet/prism cluster pair 648. Two such complete pairs 648 are shown in FIG. 6. Boundaries 650 between adjacent pairs 648 are the same as or similar to corresponding boundaries of FIG. 5.

One difference between the film 640 and the film 540 is that in the film 640, the prism vertices Vprism in a given prism cluster 643 do not lie in a common plane, unlike the prism vertices in a prism cluster 543. In the film 640, the prism vertices in a given cluster 643 lie along a curved path, as discussed below in connection with FIG. 6A.

The prism clusters 643 are characterized by a centrally located prism vertex, which is referred to as the cluster vertex and labeled Vcluster, just as in FIG. 5. In the embodiment of FIG. 6, there are 11 prisms 641 in each prism cluster 643, thus, a centrally located prism exists, and the prism axis Vprism of this prism is also labeled Vcluster for each of the prism clusters 643. Other numbers N of prisms 641 may be used in alternative embodiments, e.g., N=3, or 5, or 10 or more. The positions of prism clusters with respect to each other may be characterized by a pitch P2, as shown e.g. in FIG. 14 below. The pitch is typically uniform, but in some cases it may not be uniform. The pitch P2 may equal P1, or P2 may be slightly greater than or less than P1, as discussed above. An optical axis 625 connects the central feature of the lenslet 648, e.g. the lenslet vertex V, with the central feature of its associated prism cluster, e.g. the cluster vertex Vcluster.

In FIG. 6A, we see a magnified schematic view of one of the prism clusters 643 from FIG. 6. The prism cluster 643 is shown in relation to the focal space 655 of the associated lenslet 644. The focal space 655 is defined in the same way as the focal space 555 discussed above. Thus, the focal space 655 encompasses the focal point f and the focal surface 652 of the lenslet 644, and it is bounded by surfaces 652a, 652b, 650a, and 650b. All of these elements have the same or similar properties and characteristics as their corresponding elements in FIG. 5A. In order to provide sharp edges or transitions in the angular distribution of the light output of the lenslet and/or the film, the vertices Vprism of the prisms 641 in the prism cluster 643 are disposed at or near the focal surface 652. More particularly, all of the prism vertices Vprism in the cluster 643 are disposed in the focal space 655. The prism vertices Vprism in this embodiment are not coplanar but lie along a curved path as seen in FIG. 6A. This curved path has a curvature that is the same polarity as the curvature of the focal surface 652: both curve upwardly in FIG. 6A. Stated differently, if the focal surface 652 has a first curved shape and the prism vertices Vprism are arranged along a second curved shape in the x-z plane, the first and second curved shapes are both concave when viewed from one perspective, and they are both convex when viewed from an opposite perspective. In the embodiment of FIG. 6A, not only are the polarities of (the curvatures of) these shapes the same, but their actual curvatures are also the same or similar, such that the distance from a given prism vertex Vprism to the focal surface 652 is the same or similar for all of the prisms 641 in the prism cluster 643. As mentioned above in connection with FIG. 5A, the overall thickness of the film 640 may be increased or decreased to shift the prism cluster 643 away from the lenslet 644 (and closer to the surface 652b) or towards the lenslet 644 (and closer to the surface 652a), respectively, while ensuring that the vertices Vprism all remain within the focal space 655. For reasons given previously, it can be desirable in some circumstances to control the design parameters of the film so that some or all of the vertices Vprism are disposed in the portion of the focal space between the focal surface and the lenslet, i.e., in the region between surfaces 652, 652a, 650a, and 650b.

Each prism 641 has a vertex angle θinc, which is typically the same for all the prisms in the cluster 643, and for the prisms of other prism clusters on the second structured surface. Bisecting each vertex angle θinc is a prism axis PA, which can be considered to be an optical axis of a given prism 641. In the embodiment of FIGS. 6 and 6A, the prism axis PA of the centrally located prism 641 is parallel to the thickness axis of the film and to the optical axis 625, but the prism axes PA of the other prisms 641 in the prism cluster 643 are tilted or rotated relative those axes, the magnitude of the tilt increasing monotonically with distance from the centrally located prism, and the polarity of the tilt being different on one side of the centrally located prism compared to the other side. Providing the prisms 641 in the cluster 643 with variable tilts in a manner such as this can help to maintain sharper edges on both sides of the top hat distribution by more closely matching the focal surface 652 of the lenslet. It has the added benefit of reducing crosstalk between adjacent lenslet/prism cluster pairs by redirecting light towards the paired lenslet. The prisms 641 may be uniformly spaced along the x-axis according to a prism pitch P3 between adjacent prism vertices Vprism. Alternatively, the prisms 641 may be uniformly spaced along the curved path that connects the vertices Vprism, in which case the prism pitch P3 along the x-axis will be non-uniform: greatest at the center of the cluster 643 and least at the edges or extremities of the cluster 643.

Depending on details of construction, the film 640 of FIGS. 6 and 6A may produce a lenslet light output defining N angularly separated lobes or beams when oblique light illuminates the second structured surface 640b of the film, similar to the light output shown in FIG. 5C. Depending on the values of Imax and Imin that are achieved, some or all of the lobes may satisfy the criterion for being distinct and separate light beams as discussed above, or none of the lobes may satisfy that criterion.

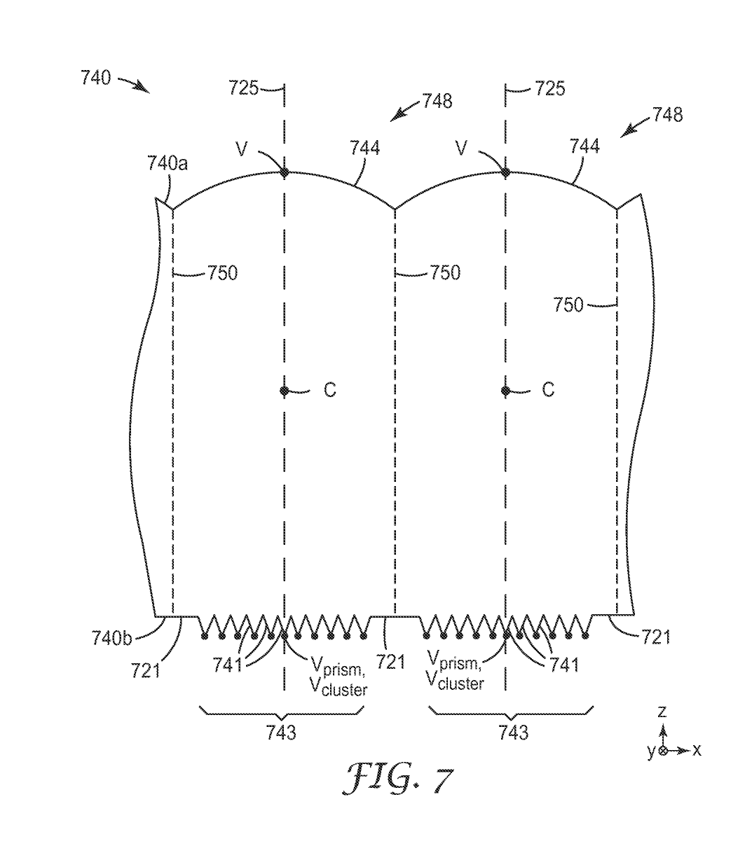

FIG. 7 shows a schematic view of a portion of another dual-sided optical film 740. The film 740 is similar to the film 540 of FIG. 5, except that adjacent prism clusters are separated by a flat surface 721 rather than a deep V-groove 520. The reader will understand that the flat surface and the V-groove are only two of many possible surface configurations and shapes that can be used in the spaces between prism clusters. In modeling investigations discussed below, a flat surface was found in at least some embodiments to reduce the intensity of sideband illumination in the light output of the optical film.

The film 740 has opposed first and second structured surfaces 740a, 740b, and is shown in relation to a Cartesian x-y-z coordinate system consistent with the previous figures. The first structured surface 740a has a plurality of lenslets 744 formed therein. Each lenslet 744 extends along an elongation axis that is parallel to the y-axis. The lenslets 744 may have a single, uniform curvature, or they may have a compound curvature. Each lenslet 744 also has a vertex V. The curvature of the lenslet 744 at its vertex V may be characterized by a center of curvature C. The vertex V and the center of curvature C for each lenslet 744 lie on an axis 725. The lenslets 744 may collectively be characterized by a pitch P1 (see e.g. FIG. 14). These various elements may be the same as or similar to corresponding elements of the film 540.

The second structured surface 740b has a plurality of prisms 741 formed therein. The prisms 741 each extend along an elongation axis parallel to the y-axis. Each prism 741 has two inclined side surfaces, which meet at a sharp peak or vertex Vprism. The prisms 741 are organized into groups or clusters 743 of adjacent prisms 741, which are separated from each other by one or more features that do not include elongated prisms. There is a one-to-one correspondence of lenslets 744 to prism clusters 743. For a given lenslet 744, one of the prism clusters 743 predominantly interacts optically with and is typically closest to the lenslet, thus, the lenslet 744 and the prism cluster 743 associated with it in this manner form a lenslet/prism cluster pair 748. Two such complete pairs 748 are shown in FIG. 7. Boundaries 750 are defined between adjacent lenslet/prism cluster pairs 748. These various elements may be the same as or similar to corresponding elements of the film 540, except that the clusters 743 are separated from each other on the structured surface 640b by flat surfaces 721 rather than by large individual V-grooves.

Design aspects of films discussed elsewhere herein can also be applied to the film 740 of FIG. 7, and, depending on details of construction, the film 740 of FIG. 7 may produce a lenslet light output defining N angularly separated lobes or beams when oblique light illuminates the second structured surface 740b of the film, similar to the light output shown in FIG. 5C. Depending on the values of Imax and Imin that are achieved, some or all of the lobes may satisfy the criterion for being distinct and separate light beams as discussed above, or none of the lobes may satisfy that criterion.

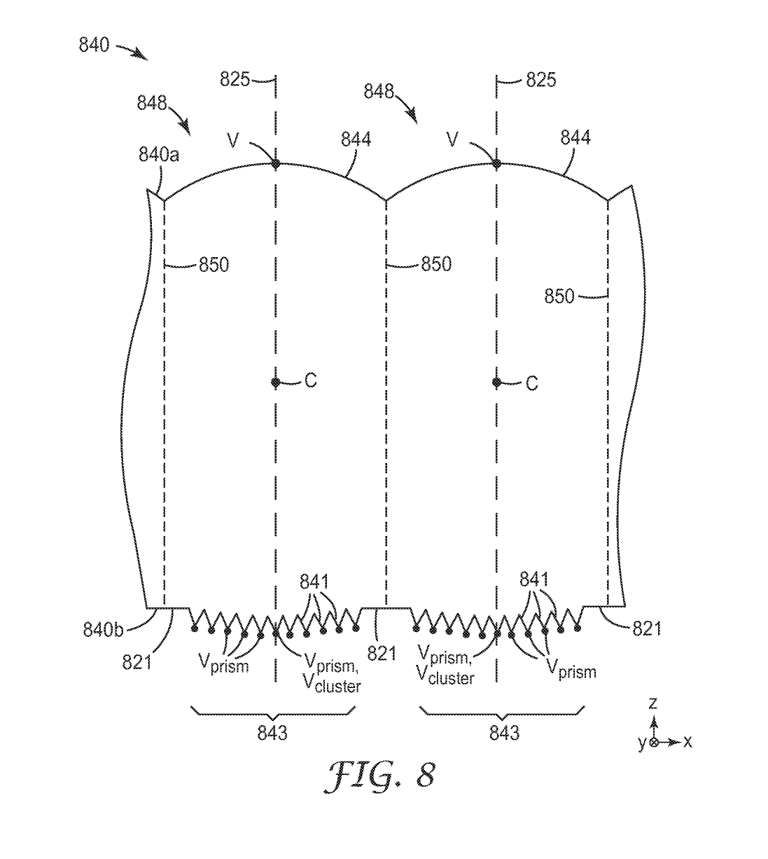

FIG. 8 shows a schematic view of a portion of another dual-sided optical film 840. The film 840 is similar to the film 640 of FIG. 6, except that adjacent prism clusters are separated by a flat surface 821 rather than a deep V-groove 620. The flat surface and the V-groove are only two of many possible surface configurations and shapes that can be used in the spaces between prism clusters. In modeling investigations discussed below, a flat surface was found in at least some embodiments to reduce the intensity of sideband illumination in the light output of the optical film.

The film 840 has opposed first and second structured surfaces 840a, 840b, and is shown in relation to a Cartesian x-y-z coordinate system consistent with the previous figures. The first structured surface 840a has a plurality of lenslets 844 formed therein. Each lenslet 844 extends along an elongation axis that is parallel to the y-axis. The lenslets 844 may have a single, uniform curvature, or they may have a compound curvature. Each lenslet 844 also has a vertex V. The curvature of the lenslet 844 at its vertex V may be characterized by a center of curvature C. The vertex V and the center of curvature C for each lenslet 844 lie on an axis 825. The lenslets 844 may collectively be characterized by a pitch P1 (see e.g. FIG. 14). These various elements may be the same as or similar to corresponding elements of the film 640.

The second structured surface 840b has a plurality of prisms 841 formed therein. The prisms 841 each extend along an elongation axis parallel to the y-axis. Each prism 841 has two inclined side surfaces, which meet at a sharp peak or vertex Vprism. The prisms 841 are organized into groups or clusters 843 of adjacent prisms 841, which are separated from each other by one or more features that do not include elongated prisms. There is a one-to-one correspondence of lenslets 844 to prism clusters 843. For a given lenslet 844, one of the prism clusters 843 predominantly interacts optically with and is typically closest to the lenslet, thus, the lenslet 844 and the prism cluster 843 associated with it in this manner form a lenslet/prism cluster pair 848. Two such complete pairs 848 are shown in FIG. 8. Boundaries 850 are defined between adjacent lenslet/prism cluster pairs 848. These various elements may be the same as or similar to corresponding elements of the film 640, except that the clusters 843 are separated from each other on the structured surface 840b by flat surfaces 821 rather than by large individual V-grooves.

Design aspects of films discussed elsewhere herein can also be applied to the film 840 of FIG. 8, and, depending on details of construction, the film 840 of FIG. 8 may produce a lenslet light output defining N angularly separated lobes or beams when oblique light illuminates the second structured surface 840b of the film, similar to the light output shown in FIG. 5C. Depending on the values of Imax and Imin that are achieved, some or all of the lobes may satisfy the criterion for being distinct and separate light beams as discussed above, or none of the lobes may satisfy that criterion.

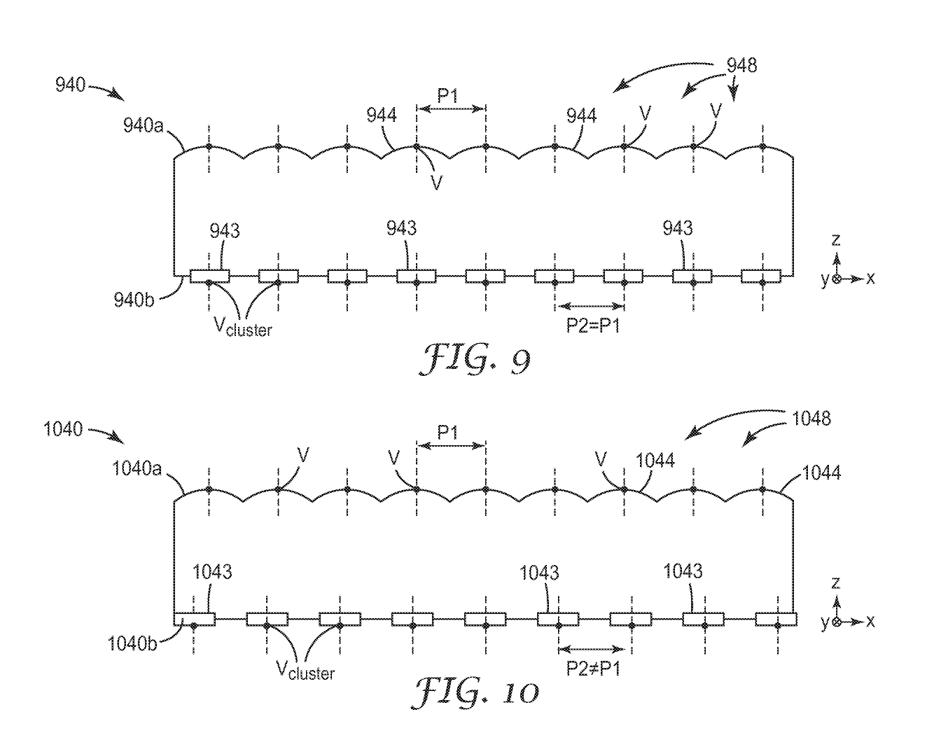

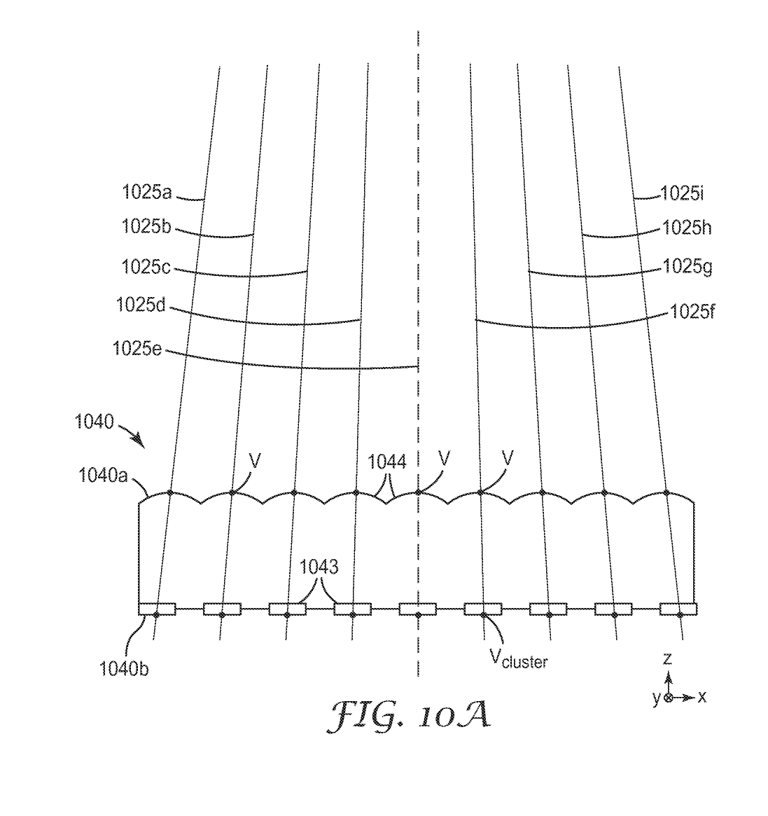

In FIGS. 9 and 10 we illustrate schematically some possible layouts of the elements on the opposed structured surfaces of the optical film, with regard to the pitch of the elements as well as the alignment or registration (or misalignment or misregistration) of elements on these opposed structured surfaces. In FIG. 9, a dual-sided optical film 940, which may be the same as or similar to any of the dual-sided optical films described herein, has a first structured surface 940a and an opposed second structured surface 940b. The first structured surface 940a has formed therein lenslets 944, each of which extends along an elongation axis parallel to the y-axis. The lenslets 944 have vertices V, centers of curvature, and focal points as described elsewhere. The lenslets 944 have a uniform pitch P1.

The second structured surface 940b of the film 940 comprises a plurality of prisms (not shown in this schematic view), each of which extends along an elongation axis parallel to the y-axis. Each of these prisms has a sharp peak or vertex which is also not shown in this schematic view. The prisms are organized into groups or clusters 943 of adjacent prisms, which are separated from each other by one or more features that do not include elongated prisms, e.g., a flat surface, a large V-groove, or other suitable surface shapes. For generality, the prism clusters 943 are shown only schematically in FIG. 9. Each prism cluster 943 is characterized by a centrally located prism vertex, which is referred to as the cluster vertex and labeled Vcluster, just as in the other figures. Each prism cluster 943 contains N individual prisms, where N is at least 3, or 5, or 10 or more, for example. The prism clusters 943 are characterized by a uniform pitch P2. P2 is assumed to equal P1. There is a one-to-one correspondence of lenslets 944 to prism clusters 943, and the association of lenslets to prism clusters produces lenslet/prism cluster pairs 948. In the film 940, nine such pairs 948 are shown. In a typical film, dozens, hundreds, or thousands of such pairs may be present.

Not only do the lenslets 944 and prism clusters 943 have the same pitch, but they are also in alignment with each other along the z-axis or thickness axis of the film 940. That is, for a given lenslet/prism cluster pair 948, the vertex V of the lenslet and the central feature Vcluster of the prism cluster have the same x-coordinate but different z-coordinates. Therefore, each lenslet/prism cluster pair 948 has an optical axis that is parallel to the z-axis. Assuming the lenslets 944 are of the same design and the prism clusters 943 are also of the same design, the lenslet/prism cluster pairs 948 will thus be substantially the same or similar to each other (except for a translation along the x-axis), and will produce lenslet light outputs whose angular distributions are also substantially the same or similar. These lenslet light outputs will then sum together to provide an overall film light output for the film 940 whose angular distribution is substantially the same as, or similar to, those of the individual lenslet light outputs. Depending on design details of the lenslets, prisms, and prism clusters, the lenslet light outputs and the film light output may define N angularly separated lobes or beams when oblique light illuminates the second structured surface 940b of the film, similar to the light output shown in FIG. 5C. Depending on the values of Imax and Imin that are achieved, some or all of the lobes may satisfy the criterion for being distinct and separate light beams as discussed above, or none of the lobes may satisfy that criterion.

The dual-sided optical film 1040 of FIG. 10 differs from that of FIG. 9 in that the lenslets have a different pitch from that of the prism clusters. The dual-sided optical film 1040, which may be the same as or similar to any of the dual-sided optical films described herein, has a first structured surface 1040a and an opposed second structured surface 1040b. The first structured surface 1040a has formed therein lenslets 1044, each of which extends along an elongation axis parallel to the y-axis. The lenslets 1044 have vertices V, centers of curvature, and focal points as described elsewhere. The lenslets 1044 have a uniform pitch P1.

The second structured surface 1040b of the film 1040 comprises a plurality of prisms (not shown in this schematic view), each of which extends along an elongation axis parallel to the y-axis. Each of these prisms has a sharp peak or vertex which is also not shown in this schematic view. The prisms are organized into groups or clusters 1043 of adjacent prisms, which are separated from each other by one or more features that do not include elongated prisms, e.g., a flat surface, a large V-groove, or other suitable surface shapes. For generality, the prism clusters 1043 are shown only schematically in FIG. 10. Each prism cluster 1043 is characterized by a centrally located prism vertex, which is referred to as the cluster vertex and labeled Vcluster, just as in the other figures. Each prism cluster 1043 contains N individual prisms, where N is at least 3, or 5, or 10 or more, for example. The prism clusters 1043 are characterized by a uniform pitch P2. P2 is assumed to be different from P1, and FIG. 10 is drawn in such a way that P2 is greater than P1. There is a one-to-one correspondence of lenslets 1044 to prism clusters 1043, and the association of lenslets to prism clusters produces lenslet/prism cluster pairs 1048. In the film 1040, nine such pairs 1048 are shown. In a typical film, dozens, hundreds, or thousands of such pairs may be present.

Since the lenslets 1044 and prism clusters 1043 have different pitches, many of them are in misalignment or misregistration with each other along the z-axis or thickness axis of the film 1040. That is, for most of the lenslet/prism cluster pairs 1048, the vertex V of the lenslet and the central feature Vcluster of the prism cluster have the different x-coordinates (as well as different z-coordinates). In the depicted embodiment, the lenslet/prism cluster pair 1048 that is located centrally within the film 1040 is assumed to have a lenslet 1044 in registration with is associated prism cluster 1043; for lenslet/prism cluster pairs 1048 that are located progressively farther away from the center of the film 1040 (and closer to the edges of the film 1040), the lenslets and prism clusters become progressively more misaligned with each other. Thus, the optical axis of the centrally located lenslet/prism cluster pair is parallel to the z-axis, but the optical axes of the other lenslet/prism cluster pairs are not, and are tilted with respect to the z-axis at angles whose magnitudes progressively increase with increasing distance from the center of the film 1040. This is shown in FIG. 10A, where the same film 1040 is shown, and the optical axes of each of the lenslet/prism cluster pairs are labeled as 1025a, 1025b, . . . 1025i. The optical axis 1025e of the centrally located lenslet/prism cluster pair is parallel to the z-axis, and it also coincides with an optical axis of the film 1040. The optical axes 1025a, 1025i of the lenslet/prism cluster pairs nearest the edge of the film 1040 are tilted the most with respect to the z-axis.

Assuming the lenslets 1044 are of the same design and the prism clusters 1043 are also of the same design, the lenslet/prism cluster pairs 1048 will thus be similar to each other except for the progressive misalignment discussed above, and will produce lenslet light outputs whose angular distributions are shifted in angle with respect to each other. These lenslet light outputs will then sum together to provide an overall film light output for the film 1040, as indicated schematically in FIG. 10A. By increasing or decreasing the ratio of the pitch P2 to the pitch P1, the point at which the optical axes 1025a, 1025b, etc. all intersect each other can be placed closer to, or farther away from, the film 1040.

For any given lenslet/prism cluster pair, but particularly for those whose optical axes are tilted with respect to the z-axis, it may be desirable for the lenslet to have an axis of symmetry or optical axis that is tilted commensurately with respect to the z-axis, as well as prisms whose individual axes of symmetry or prism axes PA are also commensurately tilted with respect to the z-axis.

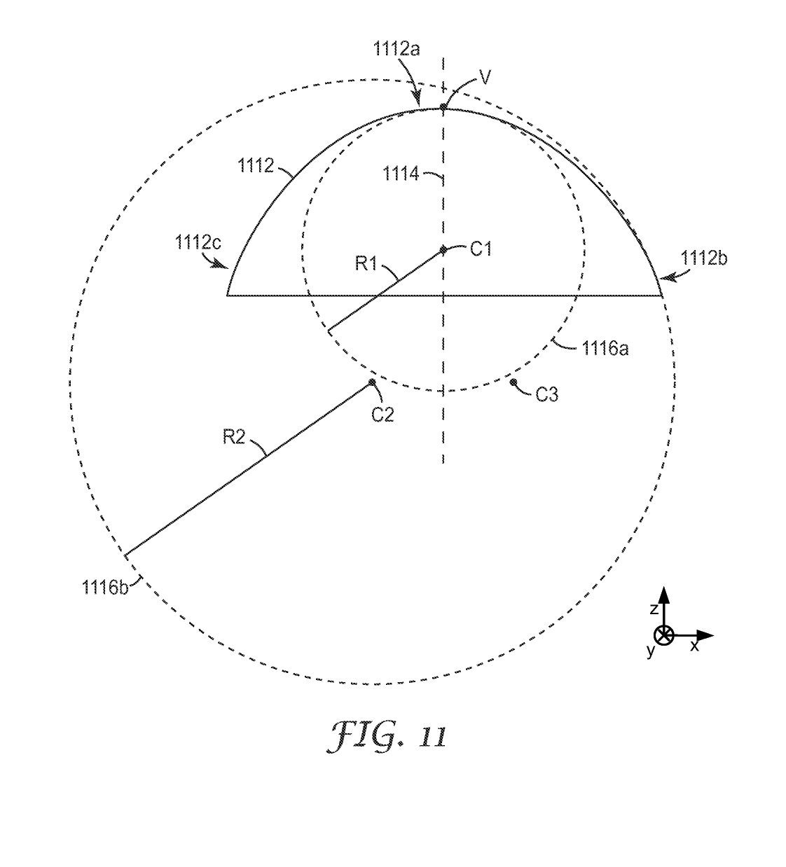

A lenslet that has a compound curvature rather than a simple curvature, when designed symmetrically, has a single, well-defined symmetry axis or optical axis. Such a lenslet 1112 is shown schematically in FIG. 11. The lenslet 1112 is assumed to extend linearly into and out of the plane of the figure, i.e., along the y-axis, and is assumed to maintain an arcuate or curved surface in cross-section in the x-z plane along the length of the feature. (The Cartesian x-y-z reference axes of FIG. 11 are consistent with those used in the previous figures.) The lenslet 1112 has a compound curvature, which means that the curvature of its arcuate surface is different at different locations on the surface. Compound curvature may be distinguished from simple curvature, wherein an arcuate surface has a constant curvature along its entire surface, as in the case of a right circular cylinder or section thereof. The compoundly-curved arcuate surface of lenslet 1112 has a vertex V at an upper or central portion of the structure. The shape of the surface in a vicinity 1112a of the vertex V has a radius of curvature R1, which corresponds to a circle 1116a whose center is C1 as shown. But as one proceeds along the surface to the peripheral portion 1112b, the curvature of the surface changes, preferably in a continuous or gradual fashion, such that at the peripheral portion 1112b the surface has a radius of curvature R2, which corresponds to a circle 1116b whose center is C2. In exemplary embodiments, the radius of curvature at the peripheral portions of the lenslet is greater than the radius of curvature at the vertex, such that R2>R1, in order to reduce certain aberrations. Also in exemplary embodiments, the lenslet exhibits a mirror symmetry, e.g. about a plane or line 1114 that passes through the vertex V and through the point C1. The line 1114 may thus be considered to be a symmetry axis and an optical axis of the lenslet 1112. Note that a peripheral portion 1112c of the surface opposite the portion 1112b may have the same curvature (R2) as the portion 1112b, where the curvature of the portion 1112c is centered at the point C3 as shown. In cases where the surface has mirror symmetry about the line 1114, the points C2 and C3 are also symmetrically disposed about the line 1114.

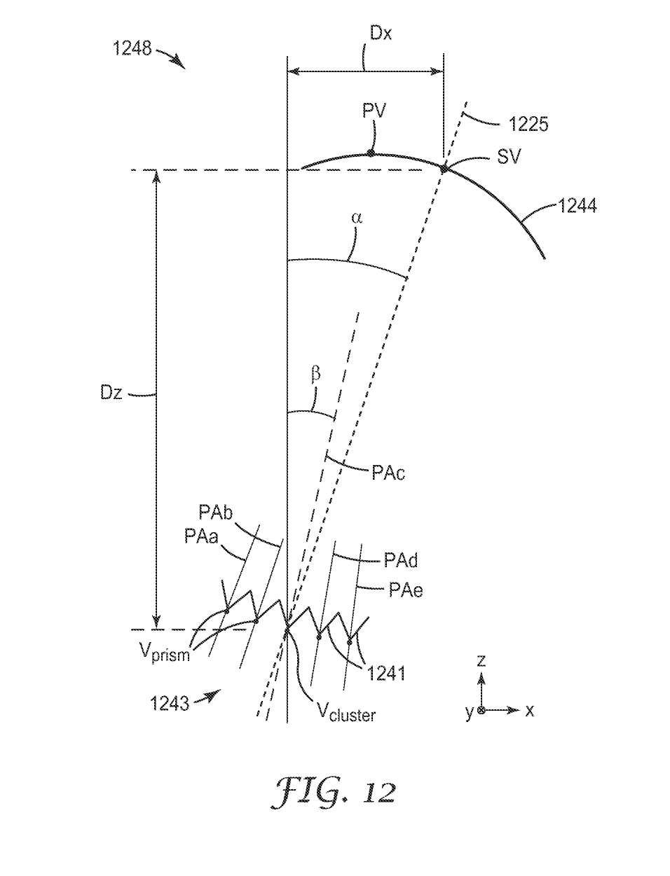

A schematic view of a generalized lenslet/prism cluster pair 1248 that may be present in any of the disclosed dual-sided optical films is shown in FIG. 12. The optical axis 1225 of the pair 1248 is tilted relative to a thickness axis of the film (the z-axis), and the pair 1248 includes a compoundly-curved lenslet 1244 having a lenslet axis of symmetry that is commensurately tilted, as well as a prism cluster 1243 whose individual prisms 1241 have prism axes PA that are also tilted. In this pair 1248, the elements are misaligned with each other both translationally and/or rotationally; they are also tilted by amounts that may be different.

The lenslet 1244 is assumed to be tilted and, as such, the simple lenslet vertex V that was shown in some of the previous figures such as FIGS. 9 and 10 degenerates into two lenslet vertices in FIG. 12: a peak vertex PV and a symmetry vertex SV. The peak vertex PV is located at the highest point on the surface of the lenslet, i.e., the point at which the z-coordinate is maximum. The symmetry vertex SV is located at a point of symmetry of the lenslet, e.g., halfway between the endpoints of the lenslet, or, if the curvature of the lenslet varies across the lenslet such that there is a local maximum or local minimum in curvature in a central portion of the lenslet, then e.g. at the point of such local maximum or minimum. The optical axis of the lenslet and the optical axis 1225 of the pair 1248 both pass through the symmetry vertex SV. For this particular embodiment, the optical axis of the lenslet is assumed to coincide with the optical axis 1225 of the pair 1248, but in other cases the optical axis of the lenslet may be tilted with respect to the optical axis of the pair.

The prism cluster 1243 is shown to have five individual prisms 1241, but the reader will understand the other numbers of (at least three) prisms may also be used. The prisms 1241 all have sharp vertices Vprism. The vertex of the prism that is centrally located within the cluster 1243 is designated the cluster vertex, Vcluster. Each prism 1241 also has a prism axis PA which bisects the vertex angle θinc of the prism. In this embodiment, the vertex angles of the prisms 1241 are assumed to be the same or similar, but the prisms 1241 are assumed to be tilted by different amounts relative to the z-axis, as exemplified by the different tilt angles of their prism axes PAa, PAb, PAc, PAd, and PAe relative to the z-axis. (In alternative embodiments, the prisms in a given cluster may all be tilted by the same amount, while prisms in different clusters may be tilted by different amounts.) The tilt of the prism cluster 1243 as a whole may be characterized best by the tilt of the centrally located prism, i.e., by the tilt of the prism axis PAc.

By appropriate selection of film thicknesses and/or coating thicknesses, the vertical distance Dz between the cluster vertex Vcluster and the lenslet symmetry vertex SV can be controlled to provide desired optical performance of the light output, also taking into consideration the refractive index of the optical film. The lenslet 1244 is translationally misaligned with the prism cluster 1243, as represented by its centrally located prism, by a displacement amount Dx along the x-axis. The lenslet 1244 is also rotationally misaligned with the prism cluster 1243: the lenslet optical axis 1225 is tilted in the x-z plane with respect to the prism axis PAc, and furthermore, both the lenslet optical axis 1225 and the prism axis PAc are tilted with respect to the z-axis. The angles α and β can be used to refer to the tilt angles of the lenslet optical axis and the central prism axis, as shown in the figure. The dual-sided optical films disclosed herein can make appropriate use of the design parameters Dz, Dx, α, and β, which may be uniform over the area of the film (for all lenslet/prism cluster pairs) or which may be non-uniform over such area. These parameters may be used to tailor lenslet light outputs and/or film light outputs as desired, such light outputs being provided when only one of two light sources is ON, or when only the other light source is ON, or when both such light sources are ON.

Dual-sided optical films that employ tilting of the prisms and/or lenslets as shown in FIG. 12 can produce an effect where the central distribution of the output light can be pointed or aimed inward to produce a converging effect e.g. as shown in FIG. 10A. Greater degrees of misalignment produce greater amounts of overlap between the angular distributions of output lights. In some cases, this approach of aiming output light distributions may be limited to an angle between the normal direction of the film (z-axis) and the central output angle of the various prism/split spreading structure pairs of about 35 degrees or less. Limits on this angle of deviation may depend on geometrical aspects of the film, such as thickness (see Dz in FIG. 12), pitch, substrate, included angle of the prism, etc., and is affected by the output distribution of the light guide.

FIG. 13 is a schematic perspective view of a dual-sided optical film 1340 whose performance was modeled. The film 1340 has opposed first and second structured surfaces 1340a, 1340b, respectively. The film 1340 has a 3-layer construction rather than a unitary construction, with a central layer 1347 of uniform thickness, representing a carrier film, and outer layers 1346, 1347 attached thereto and having the relevant structured surfaces, representing layers made by casting and curing curable polymer compositions against suitable structured tool surfaces. The central layer 1347 has a refractive index of 1.67, representative of polyethylene terephthalate (PET) and a thickness of 2 mils (50.8 microns). The outer layers 1346, 1347 have a refractive index of 1.51, representative of a cured acrylate material.

Lenslets 1344 are formed in the first structured surface 1340a, each lenslet having a vertex V as well as a focal point, a focal surface, and a focal space as described generally above. Each lenslet 1344 extends linearly along the y-axis, and has a compound curvature in the x-z plane with a mean radius of curvature of 37.3 microns, and a radius of curvature at the vertex V of 35.4 microns. The compound curvature was tailored to minimize spherical aberration at the focal point of the lenslet. The optical axis of each lenslet 1344 has a zero tilt with respect to the z-axis. The maximum thickness of the layer 1346, i.e., the physical thickness of the layer 1346 as measured at any of the lenslet vertices V, is 15 microns. The pitch of the lenslets 1344 is 50 microns.

A plurality of prisms 1341 are formed in the second structured surface 1340b. The prisms 1341 each extend linearly along an elongation axis parallel to the y-axis. Each prism 1341 has two inclined side surfaces, which meet at a sharp peak or vertex Vprism, not labeled in FIG. 13 but labeled in other figures. The prisms 1341 each have a prism angle θinc of 60 degrees, and prism axes that bisect such angles. The prisms 1341 are organized into clusters 1343 of 21 adjacent prisms 1341, which clusters are separated from each other by large individual V-grooves 1320. There is a one-to-one correspondence of lenslets 1344 to prism clusters 1343, associated ones of which form lenslet/prism cluster pairs 1348. The vertex of the prism 1341 located centrally within each cluster 1343 serves as the cluster vertex Vcluster. This centrally located prism has zero tilt with respect to the z-axis, but the other prisms 1341 in the cluster 1343 have non-zero tilts that increase to a maximum of 20 degrees at the edges of the cluster 1343. The prism vertices in a given cluster 1343 are all located in the focal space of the associated lenslet 1344, where the focal space is defined in the same way as the focal space 555 discussed above. The prism vertices in a given cluster 1343 are also non-coplanar, and lie along a curved path whose radius of curvature is 111 microns. This curved path was of the same polarity (e.g., concave or convex) as the curvature of the focal surface of the lenslet 1344. The pitch of the prisms along the x-axis ranges from 2 microns (at the center of the cluster 1343) to 1.88 microns (at the edge of the cluster 1343) (each prism 1341 being characterized relative to an adjacent prism 1341 by a 2 degree rotation about the vertex V of the lenslet 1344), and the pitch of the prism clusters 1343 is 50 microns, i.e., the same as the pitch of the lenslets 1344. Besides having the same pitch, the prism clusters 1343 and the lenslets 1344 are also aligned or registered with respect to each other, such that the optical axis of each lenslet/prism cluster pair 1348 is parallel to the z-axis.

The overall thickness or caliper of the film 1340, i.e., the physical distance from a given lenslet vertex V to its corresponding cluster vertex Vcluster, is 111 microns.

Different types of oblique light were then injected into the film 1340 to simulate a light guide emitting light into the second structured surface 1340b. A first oblique input light, referred to here as a left input distribution, had an angular distribution that was Gaussian, with a maximum intensity at an angle of 70 degrees from the z-axis with a positive x-component, and a full-width-at-half-maximum of 20 degrees. FIG. 13A shows the angular distribution of the modeled output light of the film 1340 when illuminated with this first oblique input light. A second oblique input light, referred to here as a right input distribution, also had an angular distribution that was Gaussian, with a maximum intensity at an angle of 70 degrees from the z-axis with a negative x-component, and a full-width-at-half-maximum of 20 degrees. FIG. 13B shows the angular distribution of the modeled output light of the film 1340 when illuminated with this second oblique input light. For comparison, FIG. 13C superimposes the plots of FIGS. 13A and 13B. A third oblique input light was the sum of the first and second oblique input lights. FIG. 13D shows the angular distribution of the modeled output light of the film 1340 when illuminated with this second oblique input light, i.e., the angular distribution of FIG. 13D is the sum of the angular distributions of FIGS. 13A and 13B.

Additional dual-sided optical films were also modeled and evaluated by optical simulation. FIG. 14 shows one such film 1440. The film 1440 has opposed first and second structured surfaces 1440a, 1440b, respectively. The film 1440 has a 3-layer construction, with a central layer 1447 of uniform thickness, representing a carrier film, and outer layers 1445, 1446 attached thereto and having the relevant structured surfaces, as shown. The central layer 1447 has a refractive index of 1.67 and a thickness of 2 mils (50.8 microns). The outer layers 1445, 1446 have a refractive index of 1.51.

Lenslets 1444 are formed in the first structured surface 1440a, each lenslet having a vertex V as well as a focal point, a focal surface, and a focal space as described generally above. Each lenslet 1444 extends linearly along the y-axis, and has a simple curvature in the x-z plane with a constant radius of curvature of 34.5 microns. The maximum thickness of the layer 1446, i.e., the physical thickness of the layer 1446 as measured at any of the lenslet vertices V, is 15 microns. The pitch P1 of the lenslets 1444 is 44 microns.

A plurality of prisms 1441 are formed in the second structured surface 1440b. The prisms 1441 each extend linearly along an elongation axis parallel to the y-axis. Each prism 1441 has two inclined side surfaces, which meet at a sharp peak or vertex. The prisms 1441 each have a prism angle θinc of 60 degrees, and prism axes that bisect such angles. The prisms 1441 are organized into clusters 1443 of 7 adjacent prisms 1441, which clusters are separated from each other by large individual V-grooves 1420. There is a one-to-one correspondence of lenslets 1444 to prism clusters 1443, associated ones of which form lenslet/prism cluster pairs 1448. Although only 5 complete pairs 1448 are shown in the figure, the film 1440 as modeled had exactly 21 such pairs 1448. The vertex of the prism 1441 located centrally within each cluster 1443 serves as the cluster vertex Vcluster. This centrally located prism, as well as the six other prisms 1441 in the cluster, all have zero tilt with respect to the z-axis. The prism vertices in a given cluster 1443 are all located in the focal space of the associated lenslet 1444, where the focal space is defined in the same way as the focal space 555 discussed above. The prism vertices in a given cluster 1443 are coplanar. The pitch P3 of the prisms 1441 is 4 microns, and the pitch P2 of the prism clusters 1443 is 44 microns, i.e., the same as the pitch of the lenslets 1344. Besides having the same pitch, the prism clusters 1443 and the lenslets 1444 are also aligned or registered with respect to each other, such that the optical axis of each lenslet/prism cluster pair 1448 is parallel to the z-axis.

The overall thickness or caliper D of the film 1440, i.e., the physical distance from a given lenslet vertex V to its corresponding cluster vertex Vcluster, is 101 microns.

An oblique input light was then injected into the film 1440 to simulate a light guide emitting light into the second structured surface 1440b. The input light was the sum of two Gaussian distributions, one of which had an angular distribution with a maximum intensity at an angle of 70 degrees from the z-axis with a positive x-component, and a full-width-at-half-maximum of 20 degrees, and the other of which had an angular distribution with a maximum intensity at an angle of 70 degrees from the z-axis with a negative x-component, and the same full-width-at-half-maximum. FIG. 14A shows the angular distribution of the modeled output light of the film 1440 when illuminated with this oblique input light.

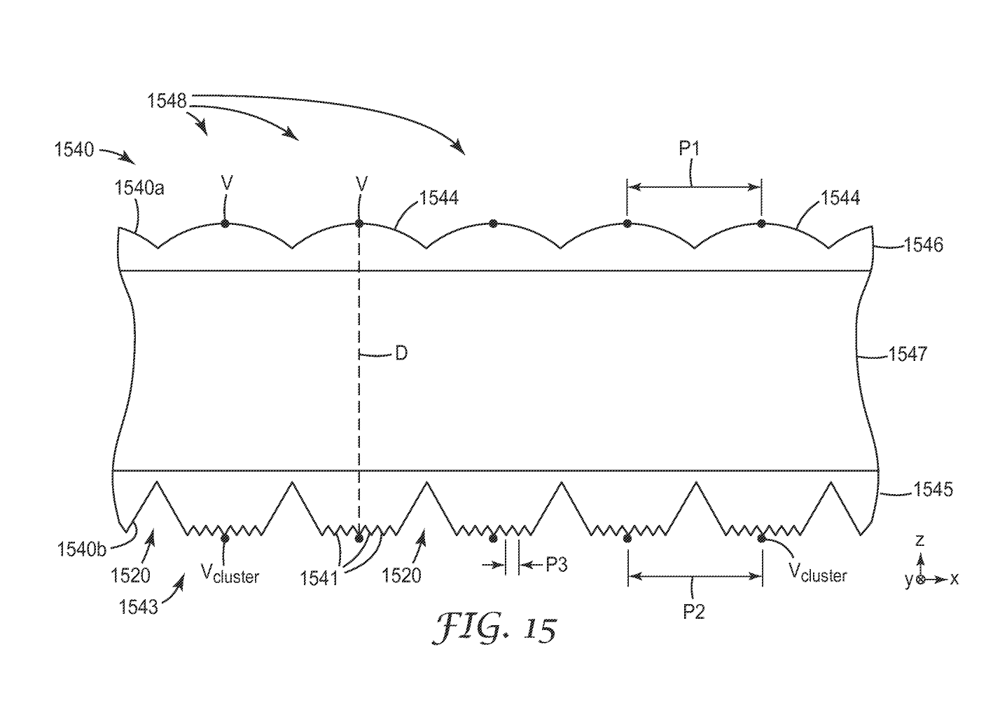

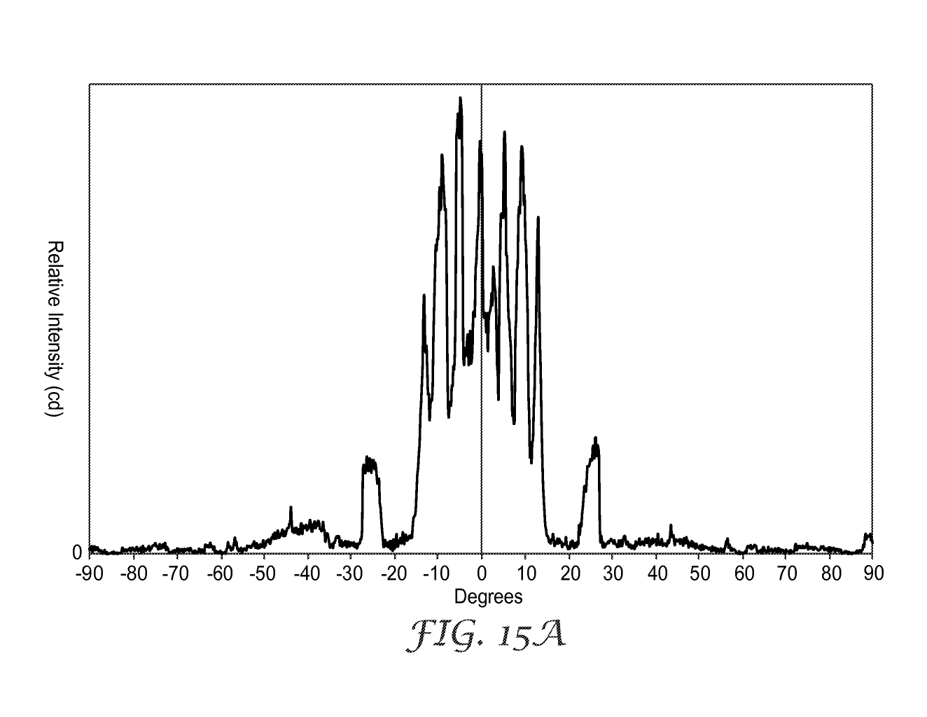

Another dual-sided optical film that was modeled and evaluated by optical simulation is shown in FIG. 15. The film 1540 was substantially the same as the film 1440, except that the thickness of the layer 1445 was reduced to shift the prisms and prism clusters along the z-axis towards the lenslets (thus reducing the overall thickness of the film), while still ensuring that the prism vertices were all within the focal space of the lenslets.

The film 1540 thus has opposed first and second structured surfaces 1540a, 1540b, respectively, and a 3-layer construction, with a central layer 1547 of uniform thickness, representing a carrier film, and outer layers 1545, 1546 attached thereto and having the relevant structured surfaces, as shown. The layers 1545, 1546, and 1547 have the same refractive indices as the corresponding layers of the film 1440, and the layer 1547 has the same thickness as the layer 1447.

Lenslets 1544 are formed in the first structured surface 1540a, each lenslet having a vertex V as well as a focal point, a focal surface, and a focal space, which are all the same as corresponding features of the lenslets 1444, the lenslets 1544 also extending linearly along the y-axis, and having a simple curvature in the x-z plane with the same constant radius of curvature as lenslets 1444. The maximum thickness of the layer 1546 is the same as that of layer 1446, and the pitch P1 of the lenslets 1544 is the same as that of lenslets 1444.

A plurality of prisms 1541 are formed in the second structured surface 1540b. The prisms 1541 each extend linearly along an elongation axis parallel to the y-axis, and the two inclined side surfaces of each prism meet at a sharp peak or vertex. The prisms 1541 have the same prism angle θinc as that of prisms 1441, and are organized into clusters 1543 of 7 adjacent prisms 1541, which clusters are separated from each other by large individual V-grooves 1520. There is a one-to-one correspondence of lenslets 1544 to prism clusters 1543, associated ones of which form lenslet/prism cluster pairs 1548. The film 1540 as modeled had exactly 21 complete pairs 1548. The vertex of the prism 1541 located centrally within each cluster 1543 serves as the cluster vertex Vcluster. This centrally located prism, as well as the six other prisms 1541 in the cluster, all have zero tilt with respect to the z-axis. The prism vertices in a given cluster 1543 are all located in the focal space of the associated lenslet 1544, where the focal space is defined in the same way as the focal space 555 discussed above. The prism vertices in a given cluster 1543 are coplanar. The pitch P3 of the prisms 1541, and the pitch P2 of the prism clusters 1543, is the same as the corresponding pitches of the film 1440, and the prism clusters 1543 and the lenslets 1544 are also aligned or registered with respect to each other.

The overall thickness or caliper D of the film 1540 was reduced relative to the corresponding dimension of the film 1440 by 15 microns, which had the effect of positioning the cluster vertex Vcluster a distance of 15 microns from the focal point of the lenslet 1540, between the focal point and the lenslet.

The same oblique input light used in connection with the film 1440 was then injected into the second structured surface 1540b of the film 1540. FIG. 15A shows the angular distribution of the modeled output light of the film 1540 when illuminated with this oblique input light. Comparing FIG. 15A with FIG. 14A, one can see that reducing the thickness of the film 1540 (relative to the film 1440) has the effect of reducing the relative differences between Imax and Imin to create a more angularly uniform top hat or fan-shaped output distribution while maintaining the leading and trailing (left and right) edges of the light output while smoothing the envelope within or between such edges.

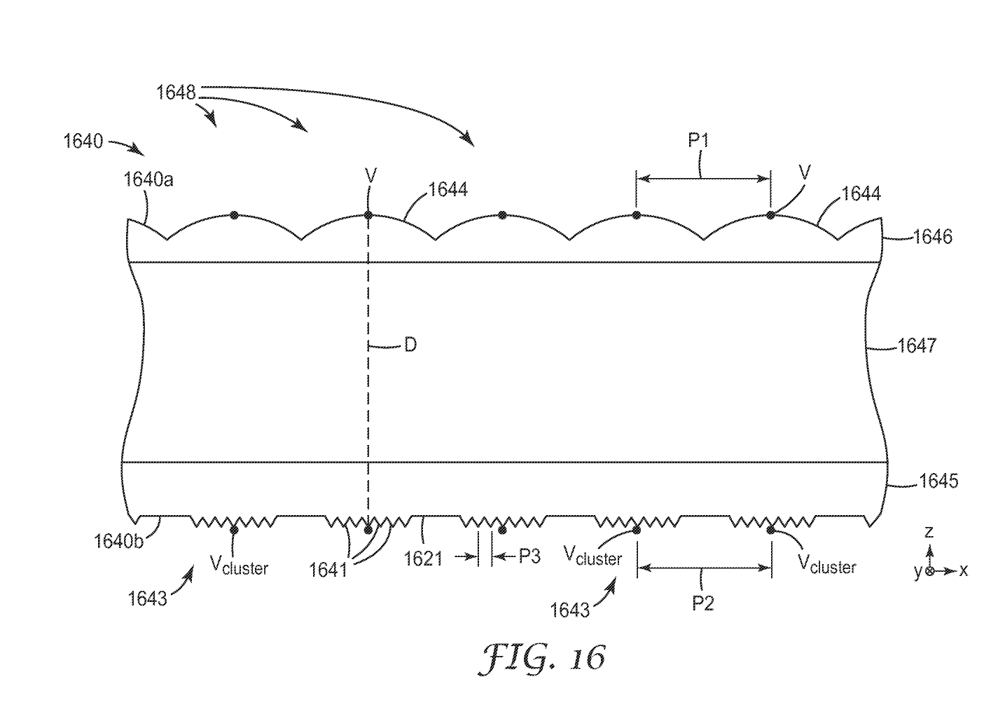

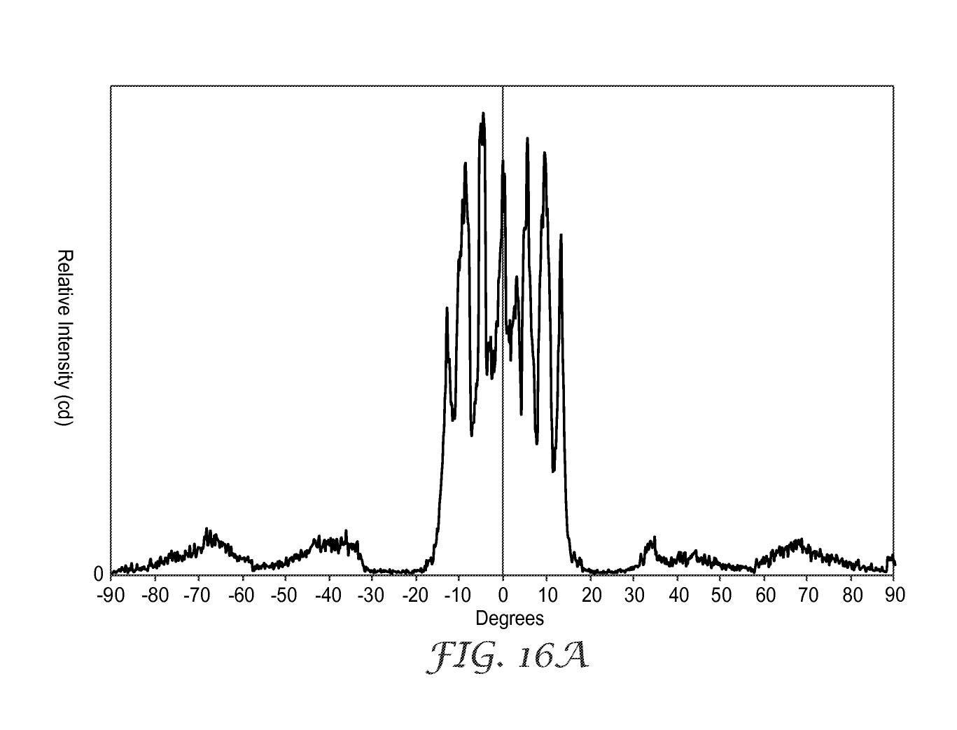

Another dual-sided optical film that was modeled and evaluated by optical simulation is shown in FIG. 16. The film 1640 was substantially the same as the film 1540, except that the surface portion between prism clusters was changed from the single deep V-groove 1520 to a flat surface.

The film 1640 thus has opposed first and second structured surfaces 1640a, 1640b, respectively, and a 3-layer construction, with a central layer 1647 of uniform thickness, representing a carrier film, and outer layers 1645, 1646 attached thereto and having the relevant structured surfaces, as shown. The layers 1645, 1646, and 1647 have the same refractive indices as the corresponding layers of the film 1540, and the layer 1647 has the same thickness as the layer 1547.

Lenslets 1644 are formed in the first structured surface 1640a, each lenslet having a vertex V as well as a focal point, a focal surface, and a focal space, which are all the same as corresponding features of the lenslets 1544, the lenslets 1644 also extending linearly along the y-axis, and having a simple curvature in the x-z plane with the same constant radius of curvature as lenslets 1544. The maximum thickness of the layer 1646 is the same as that of layer 1546, and the pitch P1 of the lenslets 1644 is the same as that of lenslets 1544.

A plurality of prisms 1641 are formed in the second structured surface 1640b. The prisms 1641 each extend linearly along an elongation axis parallel to the y-axis, and the two inclined side surfaces of each prism meet at a sharp peak or vertex. The prisms 1641 have the same prism angle θinc as that of prisms 1541, and are organized into clusters 1643 of 7 adjacent prisms 1641. Rather than being separated from each other by large individual V-grooves, the clusters 1643 are separated by flat surfaces 1621. There is a one-to-one correspondence of lenslets 1644 to prism clusters 1643, associated ones of which form lenslet/prism cluster pairs 1648. The film 1640 as modeled had exactly 21 complete pairs 1648. The vertex of the prism 1641 located centrally within each cluster 1643 serves as the cluster vertex Vcluster. This centrally located prism, as well as the six other prisms 1641 in the cluster, all have zero tilt with respect to the z-axis. The prism vertices in a given cluster 1643 are all located in the focal space of the associated lenslet 1644, where the focal space is defined in the same way as the focal space 555 discussed above. The prism vertices in a given cluster 1643 are coplanar. The pitch P3 of the prisms 1641, and the pitch P2 of the prism clusters 1643, is the same as the corresponding pitches of the film 1540, and the prism clusters 1643 and the lenslets 1644 are also aligned or registered with respect to each other.

The overall thickness or caliper D of the film 1640 was the same as the corresponding dimension of the film 1540.

The same oblique input light used in connection with the film 1540 was then injected into the second structured surface 1640b of the film 1640. FIG. 16A shows the angular distribution of the modeled output light of the film 1640 when illuminated with this oblique input light. Comparing FIG. 16A with FIG. 15A, one can see that replacing the large V-grooves with flat surfaces between prism clusters has the effect of eliminating the spurious peaks located at about +25 degrees and −25 degrees in FIG. 15A.

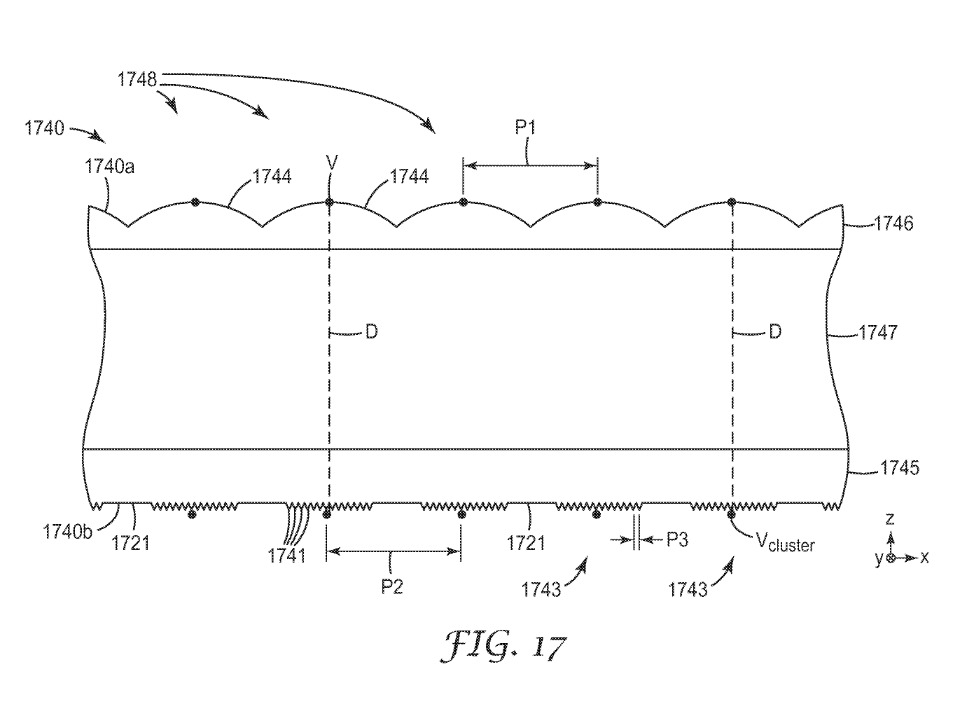

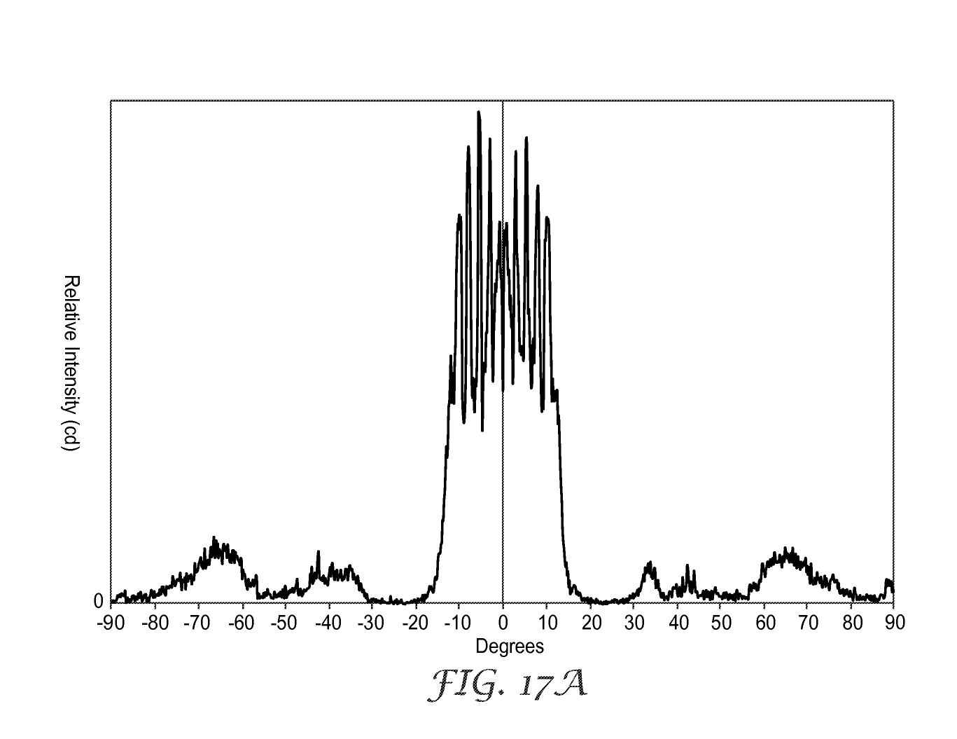

Another dual-sided optical film that was modeled and evaluated by optical simulation is shown in FIG. 17. The film 1740 was substantially the same as the film 1640, except that the 7 individual prisms in each prism cluster were replaced with 13 smaller prisms.

The film 1740 thus has opposed first and second structured surfaces 1740a, 1740b, respectively, and a 3-layer construction, with a central layer 1747 of uniform thickness, representing a carrier film, and outer layers 1745, 1746 attached thereto and having the relevant structured surfaces, as shown. The layers 1745, 1746, and 1747 have the same refractive indices as the corresponding layers of the film 1640, and the layer 1747 has the same thickness as the layer 1647.

Lenslets 1744 are formed in the first structured surface 1740a, each lenslet having a vertex V as well as a focal point, a focal surface, and a focal space, which are all the same as corresponding features of the lenslets 1644, the lenslets 1744 also extending linearly along the y-axis, and having a simple curvature in the x-z plane with the same constant radius of curvature as lenslets 1644. The maximum thickness of the layer 1746 is the same as that of layer 1646, and the pitch P1 of the lenslets 1744 is the same as that of lenslets 1644.

A plurality of prisms 1741 are formed in the second structured surface 1740b. The prisms 1741 each extend linearly along an elongation axis parallel to the y-axis, and the two inclined side surfaces of each prism meet at a sharp peak or vertex. The prisms 1741 have the same prism angle θinc as that of prisms 1641; however, rather than being organized into clusters of 7 adjacent prisms, the prisms 1741 are organized into clusters 1743 of 13 adjacent prisms 1741, and rather than having a prism pitch P3 of 4 microns, the prism pitch P3 is 2 microns. The clusters 1743 are again separated by flat surfaces 1721, and there is a one-to-one correspondence of lenslets 1744 to prism clusters 1743, associated ones of which form lenslet/prism cluster pairs 1748. The film 1740 as modeled had exactly 21 complete pairs 1748. The vertex of the prism 1741 located centrally within each cluster 1743 serves as the cluster vertex Vcluster. This centrally located prism, as well as the twelve other prisms 1741 in the cluster, all have zero tilt with respect to the z-axis. The prism vertices in a given cluster 1743 are all located in the focal space of the associated lenslet 1744, where the focal space is defined in the same way as before. The prism vertices in a given cluster 1743 are coplanar. The pitch P2 of the prism clusters 1743 is the same as the pitch P2 of the prism clusters 1643, and the prism clusters 1743 and the lenslets 1744 are also aligned or registered with respect to each other.

The overall thickness or caliper D of the film 1740 was the same as the corresponding dimension of the film 1640.

The same oblique input light used in connection with the film 1640 was then injected into the second structured surface 1740b of the film 1740. FIG. 17A shows the angular distribution of the modeled output light of the film 1740 when illuminated with this oblique input light. Comparing FIG. 17A with FIG. 16A, one can see that reducing the size of the individual prisms has the effect of increasing the number of peaks within the top hat or fan-shaped output distribution, and decreasing the angular separation of the peaks by maintaining the total angular width of the distribution, thereby smoothing the envelope within the distribution.

As can be seen in at least FIGS. 14A through 17A, the disclosed dual-sided optical films can produce a light output whose angular distribution approximates a “top hat” distribution in a plot of intensity versus angle, insofar as the distribution has a sharp left and right edge, between which is a relatively high average intensity. The intensity distribution differs from a top hat insofar as the intensity fluctuates rapidly as a function of angle, rather than being flat, between those left and right edges. The rapid fluctuations often correspond to a number N of lobes, where may N also equal the number of individual prisms in each cluster of prisms. In some cases, the rapid fluctuations may be desirable for a particular application, e.g. to provide rapidly changing illumination of objects moving along the x-direction with respect to the optical film, or to provide the film with a striped appearance for users that view the film directly.

In other cases, the rapid fluctuations may be undesirable, and a flat or flatter intensity distribution between the sharp left and right edges may be the desired. That is, the desired output may be a top hat distribution in a plot of intensity versus angle, with a high intensity that is maintained with little or no variation between the sharp left and right edges. Moreover, it may be desirable for the angular separation between the left and right edges of the light output to be substantially greater than a single spike-shaped lobe, but still limited in extent, e.g., in a range from 10 to 50 degrees, or from 20 to 40 degrees, for example. Top hat distributions such as this may be obtained with any of the disclosed optical films by adding a limited or controlled amount of light scattering. The scattering may be low enough so that the left and right edges of the light output are still sharp, but high enough so that the fluctuations between those edges mix or blend together to provide a much more uniform (flatter) intensity level. For example, the diffusion may have a FWHM angular spread of 10 degrees or less, such as provided by light shaping diffuser optical films available from Luminit, LLC, with 0.5 degree, 1 degree, 5 degree, or 10 degree FWHM diffusers. The sharpness of the left and right edges may be defined in terms of the transition angle between the 10% and 90% intensity levels, as discussed in commonly assigned U.S. patent application Ser. No. 13/850,276, “Dual-Sided Film with Compound Prisms”, filed Mar. 25, 2013. With a controlled diffuser, the 10%-to-90% transition angle for the left edge, and for the right edge, may be held to no more than 10 degrees.

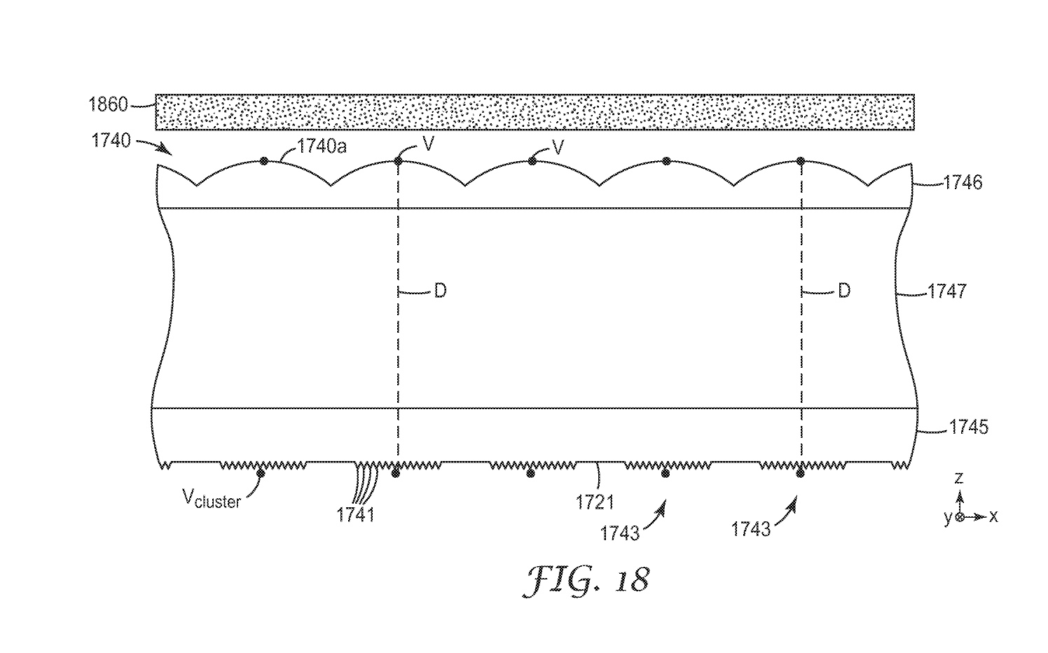

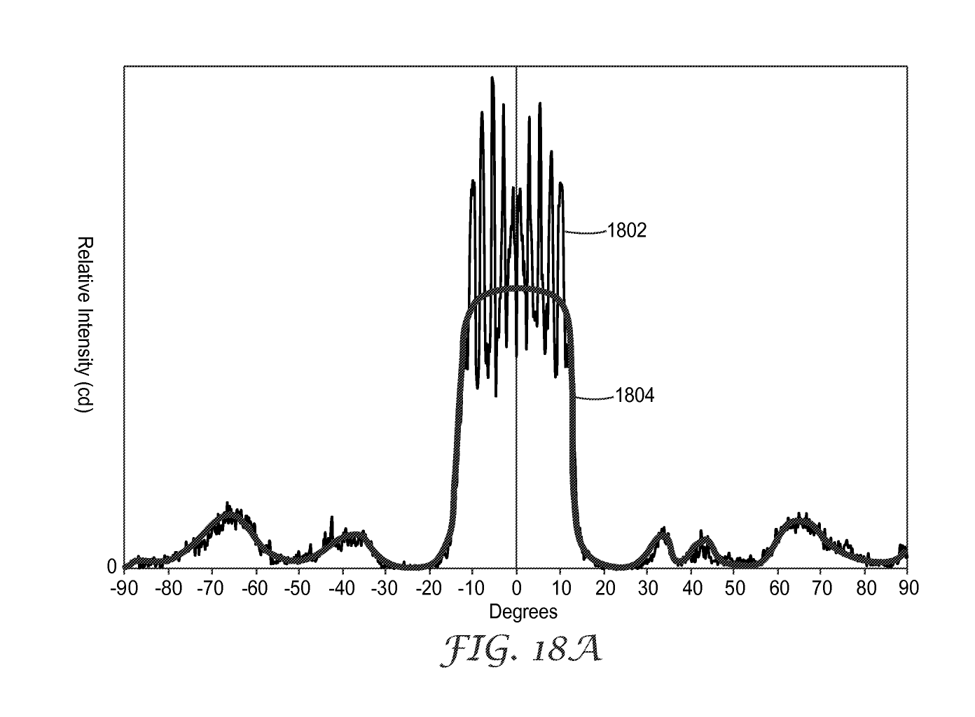

A schematic view of a system in which one of the disclosed films is combined with a controlled amount of light scattering is shown in FIG. 18. In this system, the dual-sided optical film is the film 1740 from FIG. 17, and the controlled scattering is provided by a diffuser film 1860 disposed proximate the first structured surface 1740a of the film 1740. Some reference numbers are included in FIG. 18 that are the same as those of FIG. 17, and need no further explanation. The diffuser film 1860 may be combined in any desired way with the dual-sided optical film without destroying the functionality of the dual-sided film, e.g., the film 1860 may be simply laid atop the dual-sided film, or attached thereto at small isolated locations and/or with an ultra low index (ULI) material to maintain the functionality of the lenslets on the first structured surface.

In FIG. 18A, the angular distribution of the light output of the optical film 1740 is reproduced (see FIG. 17A) and labeled 1802. The curve 1804 is an approximation of a distribution that would be expected by modifying the curve 1802 with a diffuser that scatters light over a small angular range such as 5 degrees or less, or 4 degrees or less, so as to blend or average the rapid angular fluctuations. The result much more closely approximates a top hat angular distribution for the light output of the system.

The term “intensity” as used herein may refer to any suitable measure of the brightness or strength of light, including both standard (cosine-corrected) luminance and non-cosine-corrected luminance, and radiance (cosine-corrected and non-cosine-corrected).

Numerous modifications can be made to, and numerous features incorporated into, the disclosed dual-sided optical films, light guides, and related components. For example, any given structured surface of the dual-sided optical film or of the light guide may be spatially uniform, i.e., the individual elements or structures of the structured surface may form a repeating pattern that occupies the entire major surface of the component. See e.g. FIGS. 1B and 2. Alternatively, any such structured surface may be patterned in such a way that portion(s) of the structured surface do not contain such individual elements or structures, or that the portion(s) contain such individual elements or structures, but such elements or structures have been rendered completely or partially inoperative. The absence of such individual elements or structures over portion(s) of the structured surface may be achieved by forming the elements or structures over the entire major surface, and then destroying or otherwise removing them by any suitable technique, e.g., applying sufficient heat and/or pressure to flatten the elements or structures, but selectively (pattern-wise) in the desired portion(s). Alternatively, the absence of the individual elements or structures may be achieved by not forming them in the desired portion(s) of the structured surface at the time when elements or structures are being formed in other regions of the structured surface, e.g. using a suitably patterned tool. In cases where individual elements or structures are rendered completely or partially inoperative in desired portion(s) of the structured surface, the structured surface may initially be spatially uniform, but individual elements or structures may then be coated or otherwise covered in a pattern-wise fashion with an adhesive, printing medium, or other suitable material whose refractive index matches (including substantially matches) the refractive index of the elements or structures, or that at least has a refractive index different from than air or vacuum. Such a pattern-wise applied material, which may be cured or crosslinked after application to the structured surface, may planarize the desired portion(s) of the structured surface. Whether the individual elements or structures are omitted or rendered inoperative, the optical system may be designed such that only one structured surface (e.g. a structured surface of the light guide, or a structured surface of the dual-sided film) is patterned, or only two structured surfaces are patterned, or only three structured surfaces are patterned, or four structured surfaces are patterned. If more than two structured surfaces are patterned, the same pattern may be used for any two patterned surfaces, or different patterns may be used.

In other alternatives, with a suitably designed light guide, two dual-sided optical films can be used on opposite sides of the light guide. The light guide may be configured to provide oblique light beams from each of its two opposed major surfaces, and one dual-sided film can be provided at each major surface of the light guide to convert the oblique light beam to a fan-shaped light output (including in some cases a top hat angular distribution) on each side of the light guide. For example, in FIG. 1B, a dual-sided film which is a mirror image (relative to the x-y plane) of the film 140 may be placed on the opposite side of the light guide 150 such that the light guide is disposed between the two mirror-image dual-sided optical films.

In other alternatives, the optical system may also include secondary structures to limit or reduce the degree of light spreading of the light output produced by the dual-sided optical film. For example, a conventional louvered privacy film and/or a shroud (e.g. including one or more light blocking members) may be provided at the output of the dual-sided film. These secondary structures may operate by occluding a portion of a given initial light output in the x-z plane and/or in the y-z plane to produce a modified output beam, the modified output beam being narrower than the initial output beam in the plane(s) of occlusion.

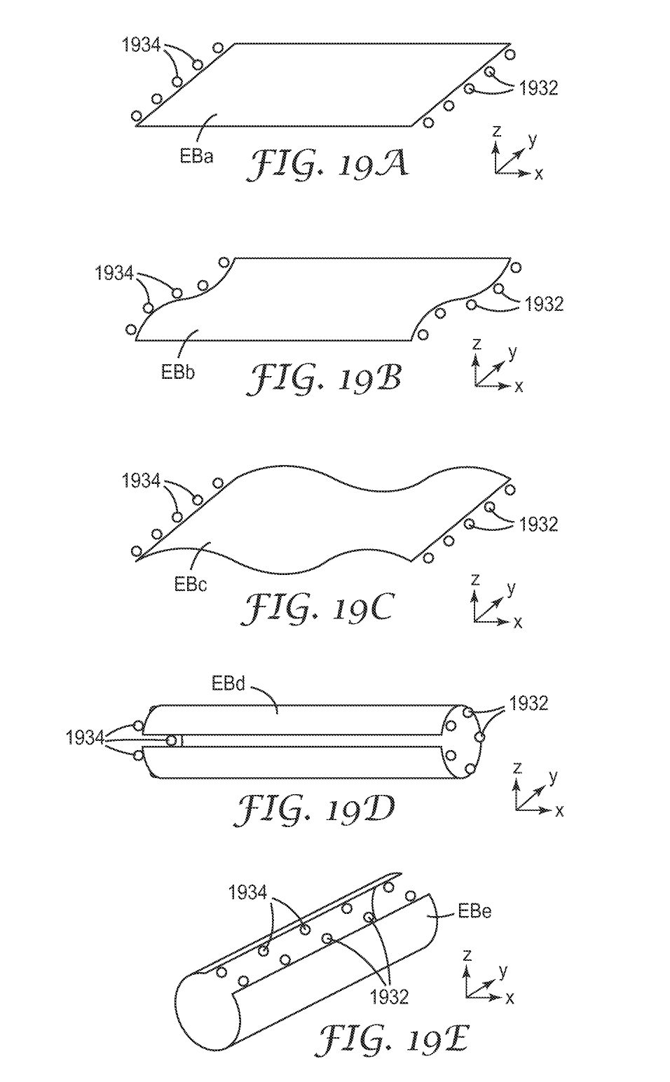

The light guide and the dual-sided optical film may both be substantially planar in overall shape, or one or both may be non-planar. Exemplary lighting system embodiments are schematically depicted in FIGS. 19A through 19E. In each of these figures, first light sources 1934 and second light sources 1932 are provided along opposed edges of an extended body. The light sources 1934, 1932 may be the same as or similar to light sources 134, 132 discussed above. The extended body, which is labeled EBa in FIG. 19A, EBb in FIG. 19B, EBc in FIG. 19C, EBd in FIG. 19D, and EBe in FIG. 19E, may represent the light guide, the dual-sided optical film, or both. The extended bodies of these figures are shown in relation to Cartesian x-y-z coordinate systems consistent with the previous figures. Deviations from planarity may be indicative of a flexible extended body, or a physically rigid extended body that was formed in a non-planar fashion. The extended body EBa is substantially planar, extending parallel to the x-y plane. The extended body EBb is non-planar, with curvature in the y-z plane but not in the x-z plane. The extended body EBc is also non-planar, but with curvature in the x-z plane and not in the y-z plane. Alternative embodiments may have curvature in both the x-z plane and the y-z plane. The extended body EBd is non-planar, with curvature in the y-z plane but not in the x-z plane, and the curvature in the y-z plane is such that the body closes in upon itself to form a tubular structure. The tubular structure may include a lengthwise slot or gap as shown. The tubular structure may have a substantially circular shape in transverse cross section (e.g., a cross section in the y-z plane), or alternatively an elliptical or other non-circular shape. The extended body EBd is non-planar, but with curvature in the x-z plane and not in the y-z plane, and the curvature in the x-z plane is such that the body closes in upon itself to form a tubular structure. The tubular structure may include a lengthwise slot or gap as shown. The tubular structure may have a substantially circular shape in transverse cross section (e.g., a cross section in the x-z plane), or alternatively an elliptical or other non-circular shape. Lighting systems having any of the shapes of FIGS. 19A through 19E may be constructed in any desired form factor, including a form factor similar to a conventional light bulb, and may be used in place of conventional light bulbs, with the added capability of switchable output beam distributions as a function of which light sources are energized.

Unless otherwise indicated, all numbers expressing quantities, measurement of properties, and so forth used in the specification and claims are to be understood as being modified by the term “about”. Accordingly, unless indicated to the contrary, the numerical parameters set forth in the specification and claims are approximations that can vary depending on the desired properties sought to be obtained by those skilled in the art utilizing the teachings of the present application. Not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, to the extent any numerical values are set forth in specific examples described herein, they are reported as precisely as reasonably possible. Any numerical value, however, may well contain errors associated with testing or measurement limitations.

Any direction referred to herein, such as “top,” “bottom,” “left,” “right,” “upper,” “lower,” “above,” below,” and other directions and orientations are used for convenience in reference to the figures and are not to be limiting of an actual device, article, or system or its use. The devices, articles, and systems described herein may be used in a variety of directions and orientations.

Various modifications and alterations of this invention will be apparent to those skilled in the art without departing from the spirit and scope of this invention, and it should be understood that this invention is not limited to the illustrative embodiments set forth herein. The reader should assume that features of one disclosed embodiment can also be applied to all other disclosed embodiments unless otherwise indicated. It should also be understood that all U.S. patents, patent application publications, and other patent and non-patent documents referred to herein are incorporated by reference, to the extent they do not contradict the foregoing disclosure.

This document discloses numerous embodiments, including but not limited to the following:

Item 1 is an optical film having opposed first and second structured surfaces, the optical film comprising:
a plurality of elongated lenslets formed on the first structured surface, the lenslets being elongated along respective lenslet axes which are parallel to an elongation axis; and
a plurality of elongated prisms formed on the second structured surface, the prisms having respective elongated prism vertices which are also parallel to the elongation axis;
wherein the prisms are grouped into prism clusters that are separated from each other, each prism cluster having at least three of the prisms, and each prism cluster being associated with a corresponding one of the lenslets;
wherein each lenslet defines a focal surface, and wherein for each lenslet, the prism vertices of the prisms in the prism cluster associated with the lenslet are disposed at or near the focal surface.
   Item 2 is the film of item 1, wherein for each lenslet, the lenslet has an axial focal length, and a focal space encompasses the focal surface and has boundaries that are separated from the focal surface by a differential distance DD equal to 20% of the axial focal length, and wherein the prism vertices of the prisms in the prism cluster associated with the lenslet are disposed in the focal space of the lenslet.
   Item 3 is the film of item 2, wherein, for each lenslet, the prism vertices of the prisms in the prism cluster associated with the lenslet are disposed in a portion of the focal space between the focal surface and the lenslet.
   Item 4 is the film of item 1, wherein for each lenslet, the prism vertices of the prisms in the prism cluster associated with the lenslet lie in a plane.
   Item 5 is the film of item 1, wherein for each lenslet, the focal surface has a first curved shape in a cross-sectional plane perpendicular to the elongation axis.
   Item 6 is the film of item 5, wherein, for each lenslet, the prism vertices of the prisms in the prism cluster associated with the lenslet are arranged along a second curved shape in the cross-sectional plane.
   Item 7 is the film of item 6, wherein the first and second curved shapes are both concave or both convex.
   Item 8 is the film of item 1, wherein each prism cluster includes 5 of the prisms.
   Item 9 is the film of item 8, wherein each prism cluster includes 10 of the prisms.
   Item 10 is the film of item 1, wherein the prism clusters each contain a same number N of the prisms, where N is at least 3, or at least 5, or at least 10.
   Item 11 is the film of item 1, wherein for each lenslet, the associated prism cluster has N of the prisms, and the lenslet cooperates with its associated prism cluster to provide, when the second structured surface is illuminated with oblique light from a first light source, a first lenslet light output defining N angularly separated light beams, and N is at least 3.
   Item 12 is the film of item 11 in combination with a diffuser film disposed to receive the first lenslet light output and to convert the N angularly separated light beams to one light beam.
   Item 13 is the film of item 1, wherein the optical film defines a film plane and a thickness axis is perpendicular to the film plane, and wherein at least some of the lenslets have a compound curvature in a cross-sectional plane perpendicular to the elongation axis, such lenslets also having respective lenslet axes of symmetry in the cross-sectional plane, and wherein at least some of the lenslet axes of symmetry are tilted relative to the thickness axis.
   Item 14 is the film of item 1, wherein the optical film defines a film plane and a thickness axis is perpendicular to the film plane, and wherein the prisms have respective prism axes of symmetry in a cross-sectional plane perpendicular to the elongation axis, and wherein at least some of the prism axes of symmetry are tilted relative to the thickness axis.
   Item 15 is the film of item 1, wherein the lenslets are spaced according to a lenslet pitch and the prism clusters are spaced according to a cluster pitch, and wherein the lenslet pitch equals the cluster pitch.
   Item 16 is the film of item 1, wherein the lenslets are spaced according to a lenslet pitch and the prism clusters are spaced according to a cluster pitch, and wherein the lenslet pitch does not equal the cluster pitch.
   Item 17 is the film of item 1 in combination with a diffuser film disposed proximate the first structured surface.
   Item 18 is an optical system, comprising:
the optical film of item 1; and
a light guide having a major surface adapted to emit light preferentially at oblique angles;
wherein the optical film is disposed proximate the light guide and oriented so that light emitted from the major surface of the light guide enters the optical film through the second structured surface.
   Item 19 is the optical system of item 18, further comprising a first and second light source disposed proximate respective first and second opposed ends of the light guide, the first and second light sources providing different respective first and second oblique light beams emitted from the major surface of the light guide.
   Item 20 is the optical system of item 18, wherein the optical film and the light guide are non-planar.
   Item 21 is the optical system of item 18, wherein the optical film and the light guide are flexible.
   Item 22 is the optical system of item 18, wherein the optical film is attached to the light guide.

What is claimed is:

1. An optical film having opposed first and second structured surfaces, the optical film comprising:
a plurality of elongated lenslets formed on the first structured surface, the lenslets being elongated along respective lenslet axes which are parallel to an elongation axis; and
a plurality of elongated prisms formed on the second structured surface, the prisms having respective elongated prism vertices which are also parallel to the elongation axis;
wherein the prisms are grouped into prism clusters that are separated from each other, each prism cluster having at least three of the prisms, and each prism cluster being associated with a corresponding one of the lenslets;
wherein each lenslet defines a focal surface, and wherein for each lenslet, the prism vertices of the prisms in the prism cluster associated with the lenslet are disposed at or near the focal surface.

2. The film of claim 1, wherein for each lenslet, the lenslet has an axial focal length, and a focal space encompasses the focal surface and has boundaries that are separated from the focal surface by a differential distance DD equal to 20% of the axial focal length, and wherein the prism vertices of the prisms in the prism cluster associated with the lenslet are disposed in the focal space of the lenslet.

3. The film of claim 1, wherein for each lenslet, the focal surface has a first curved shape in a cross-sectional plane perpendicular to the elongation axis.

4. The film of claim 3, wherein, for each lenslet, the prism vertices of the prisms in the prism cluster associated with the lenslet are arranged along a second curved shape in the cross-sectional plane.

5. The film of claim 4, wherein the first and second curved shapes are both concave or both convex.

6. The film of claim 1, wherein the optical film defines a film plane and a thickness axis is perpendicular to the film plane, and wherein at least some of the lenslets have a compound curvature in a cross-sectional plane perpendicular to the elongation axis, such lenslets also having respective lenslet axes of symmetry in the cross-sectional plane, and wherein at least some of the lenslet axes of symmetry are tilted relative to the thickness axis.

7. An optical system, comprising:
the optical film of claim 1; and
a light guide having a major surface adapted to emit light preferentially at oblique angles;
wherein the optical film is disposed proximate the light guide and oriented so that light emitted from the major surface of the light guide enters the optical film through the second structured surface.

8. The optical system of claim 7, further comprising a first and second light source disposed proximate respective first and second opposed ends of the light guide, the first and second light sources providing different respective first and second oblique light beams emitted from the major surface of the light guide.

9. The optical system of claim 7, wherein the optical film and the light guide are non-planar.

10. The optical system of claim 7, wherein the optical film and the light guide are flexible.
